(19) United States
(12) Patent Application Publication
(10) Pub. No.: US 2025/0159252 A1
(43) Pub. Date: May 15, 2025

(54) VIDEO CODING METHOD, APPARATUS AND SYSTEM

(71) Applicant: GUANGDONG OPPO MOBILE TELECOMMUNICATIONS CORP., LTD., Dongguan (CN)

(72) Inventor: Luhang XU, Dongguan (CN)

(73) Assignee: GUANGDONG OPPO MOBILE TELECOMMUNICATIONS CORP., LTD., Dongguan (CN)

(21) Appl. No.: 19/024,962

(22) Filed: Jan. 16, 2025

Related U.S. Application Data
(63) Continuation of application No. PCT/CN2022/112282, filed on Aug. 12, 2022.

(51) Int. Cl. H04N 19/593; H04N 19/105; H04N 19/176; H04N 19/70

(52) U.S. Cl. CPC H04N 19/593; H04N 19/105; H04N 19/176; H04N 19/70

(57) ABSTRACT

A video coding method, apparatus and a system are provided. During decoding of a current block, a TMRL enabled flag is used. Whether it is allowed to encode or decode a TMRL mode syntax element for the current block is determined based on a value of the TMRL enabled flag.

### CROSS-REFERENCE TO RELATED APPLICATIONS

This application is a continuation of International Application No. PCT/CN2022/112282, filed on Aug. 12, 2022, the disclosure of which is hereby incorporated by reference in its entirety.

### TECHNICAL FIELD

Embodiments of this application relate to, but are not limited to, a video technology, and more specifically, the embodiments of this application relate to a video coding method, apparatus and system.

### BACKGROUND

Digital video compression technologies primarily compress huge amounts of digital images and video data, to facilitate efficient transmission and storage. In general video coding standards, such as H.266/versatile video coding (VVC), a block-based hybrid encoding framework is used. Each picture in a video is partitioned into square largest coding units (LCU) of a same size (for example, 128×128, or 64×64). Each largest coding unit may be partitioned into rectangular coding units (CU) according to rules. A coding unit may be further partitioned into a prediction unit (PU), a transform unit (TU), and the like. The hybrid encoding framework includes a prediction module, a transform module, a quantization module, an entropy encoding module, an in-loop filtering module, and the like. The prediction module includes intra prediction and inter prediction, which are used to reduce or eliminate redundancies within a video. An intra block is predicted using pixels around the block as a reference, while an inter block is predicted using information of a spatially adjacent block and reference information of other pictures. Relative to a prediction signal, residual information in blocks is transformed, quantized, and entropy encoded to form a bitstream. These technologies are described in standards and implemented in various fields related to video compression.

With the explosive growth of internet video content and the increasing demand of people for higher video quality, existing digital video compression standards can save significant amounts of video data. However, there remains a need to develop more advanced digital video compression technologies to further alleviate bandwidth and data traffic pressures during digital video transmission.

### SUMMARY

The following is a summary of subjects detailed herein. The summary is not intended to limit the protection scope of the claims.

An embodiment of this application provides a video decoding method, applied to a decoder. The video decoding method includes:
determining a value of a template-based multiple reference line intra prediction TMRL enabled flag by decoding; and
during decoding of a current block:
in a case in which the value of the TMRL enabled flag indicates that a TMRL mode is allowed to be used, allowing to decode a TMRL mode syntax element for the current block; or
in a case in which the value of the TMRL enabled flag indicates that a TMRL mode is not allowed to be used, skipping decoding a TMRL mode syntax element for the current block.

An embodiment of this application further provides a video encoding method, applied to an encoder. The video encoding method includes:
determining a value of a template-based multiple reference line intra prediction TMRL enabled flag; and
during encoding of a current block:
in a case in which the value of the TMRL enabled flag indicates that a TMRL mode is allowed to be used, allowing to encode a TMRL mode syntax element for the current block; or
in a case in which the value of the TMRL enabled flag indicates that a TMRL mode is not allowed to be used, skipping encoding a TMRL mode syntax element for the current block.

An embodiment of this application further provides a bitstream. The bitstream is generated by using the video encoding method according to any one of the embodiments of this application.

An embodiment of this application further provides a video decoding apparatus. The video decoding apparatus includes a processor and a memory storing a computer program, where the computer program is executed by the processor to implement the video decoding method according to any one of the embodiments of this application.

An embodiment of this application further provides a video encoding apparatus. The video encoding apparatus includes a processor and a memory storing a computer program, where the computer program is executed by the processor to implement the video encoding method according to any one of the embodiments of this application.

An embodiment of this application further provides a video coding system. The video coding system includes the video encoding apparatus according to any one of the embodiments of this application and the video decoding apparatus according to any one of the embodiments of this application.

An embodiment of this application further provides a non-transitory computer-readable storage medium storing a computer program, where the computer program is executed by a processor to implement the video decoding method according to any one of the embodiments of this application, or to implement the video encoding method according to any one of the embodiments of this application.

After reading and understanding the drawings and detailed descriptions, other aspects can be understood.

### BRIEF DESCRIPTION OF THE DRAWINGS

The drawings are used to provide an understanding of embodiments of this application and form a part of the specification, and explain technical solutions of this application together with the embodiments of this application, and do not constitute a limitation on the technical solutions of this application.

FIG. 1A is a schematic diagram of a coding system according to an embodiment of this application.

FIG. 1B is a frame diagram of an encoding side according to an embodiment of this application.

FIG. 1C is a frame diagram of a decoding side according to an embodiment of this application.

FIG. 2 is a schematic diagram of an intra prediction mode according to an embodiment of this application.

FIG. 3 is a schematic diagram of intra predicted blocks adjacent to a current block according to an embodiment of this application.

FIG. 4 is a schematic diagram of template regions and template reference regions of a current block according to an embodiment of this application.

FIG. 5 is a schematic diagram of a plurality of reference lines around a current block according to an embodiment of this application.

FIG. 6 is a flowchart of a video encoding method according to an embodiment of this application.

FIG. 7 is a flowchart of a method for constructing a candidate list of a TMRL mode according to an embodiment of this application.

FIG. 8A is a schematic diagram of template regions and extended reference lines around a current block according to an embodiment of this application.

FIG. 8B is a schematic diagram of template regions and extended reference lines around a current block according to another embodiment of this application.

FIG. 9 is a flowchart of a video decoding method according to an embodiment of this application.

FIG. 10 is a flowchart of a video decoding method according to another embodiment of this application.

FIG. 11 is a flowchart of a video encoding method according to another embodiment of this application.

FIG. 12 is a schematic diagram of a video decoding apparatus according to an embodiment of this application.

### DETAILED DESCRIPTION OF THE EMBODIMENTS

This application provides descriptions of a plurality of embodiments, but the descriptions are illustrative, rather than restrictive. In addition, it is obvious for those of ordinary skill in the art that there may be more embodiments and implementations within the scope of the embodiments described in this application.

In the descriptions of this application, terms such as “exemplary” or “for example” are used to represent an example, an instance, or an illustration. Any embodiment described as “exemplary” or “for example” in this application should not be construed as being more preferred or advantageous than other embodiments. In this specification, the term “and/or” is a description of an association relationship between associated objects, and represents that there may be three relationships. For example, A and/or B may represent three cases: only A exists, both A and B exist, and only B exists. “A plurality of” means two or more than two. In addition, to clearly describe the technical solutions in the embodiments of this application, terms, such as “first” and “second”, are used to distinguish between same items or similar items that have essentially the same function and usage. Those skilled in the art may understand that the terms, such as “first” and “second”, are not intended to limit a quantity or execution order; and the terms, such as “first” and “second”, do not indicate a definite difference.

When representative exemplary embodiments are described, methods and/or processes may be presented as specific sequences of steps in the specification. However, to an extent that the methods or processes are independent of the specific order of the steps described herein, the methods or processes should not be limited to the steps in the specific order. As those of ordinary skill in the art will understand that other step sequences are also possible. Therefore, the specific order of the steps described in the specification should not be interpreted as a limitation on the claims. In addition, the claims for the methods and/or processes should not be limited to steps being performed in the described order. Those skilled in the art can easily understand that the order of the steps may vary while still remaining within the spirit and scope of the embodiments of this application.

The video coding method provided in the embodiments of this application may be applied to various video coding standards, such as H.264/Advanced Video Coding (AVC), H.265/High Efficiency Video Coding (HEVC), H.266/Versatile Video Coding (VVC), and AVS (Audio Video coding Standard), and other standards formulated by the MPEG (Moving Picture Experts Group), AOM (Alliance for Open Media), and JVET (joint video experts team) and their extensions, or any other customized standards.

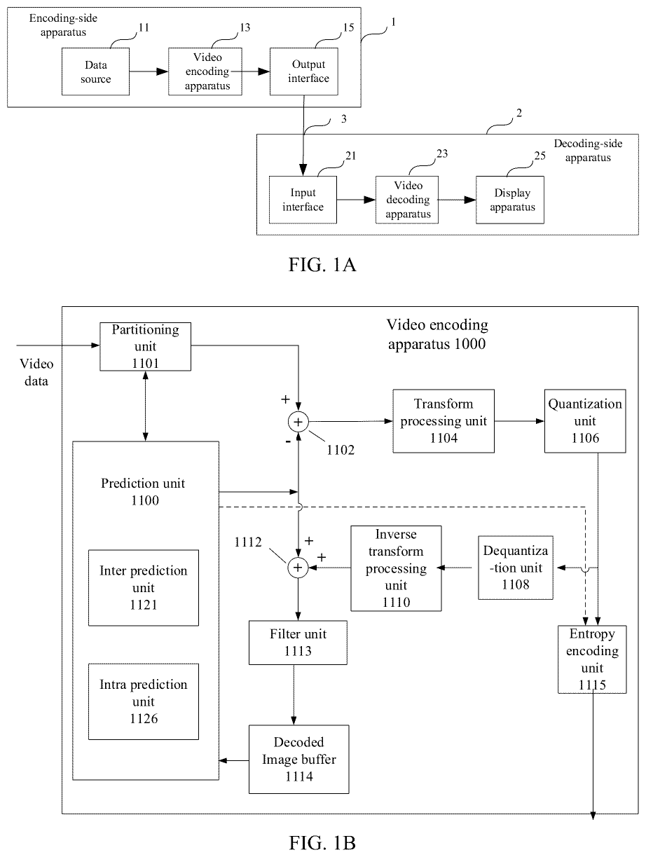

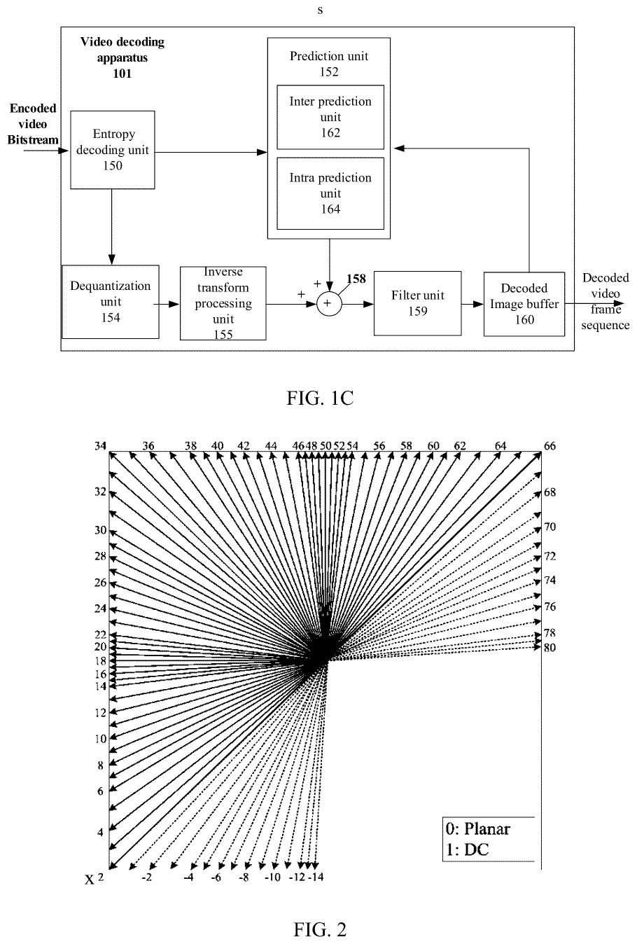

FIG. 1A is a block diagram of a video coding system applicable to an embodiment of this application. As shown in the figure, the system includes an encoding-side apparatus 1 and a decoding-side apparatus 2, with the encoding-side apparatus 1 generating a bitstream. The decoding-side apparatus 2 may decode the bitstream. The decoding-side apparatus 2 may receive the bitstream from the encoding-side apparatus 1 via a link 3. The link 3 includes one or more media or apparatuses that can move the bitstream from the encoding-side apparatus 1 to the decoding-side apparatus 2. In an example, the link 3 includes one or more communication media that causes the encoding-side apparatus 1 to directly transmit the bitstream to the decoding-side apparatus 2. The encoding-side apparatus 1 modulates the bitstream according to a communication standard (for example, a wireless communication protocol) and transmits the modulated bitstream to the decoding-side apparatus 2. The one or more communication media may include wireless and/or wired communication media, which may constitute part of a packet network. In another example, the bitstream may alternatively be output from an output interface 15 to a storage apparatus. The decoding-side apparatus 2 may read the stored data from the storage apparatus through streaming or downloading.

As shown in the figure, the encoding-side apparatus 1 includes a data source 11, a video encoding apparatus 13, and the output interface 15. The data source 11 includes a video capture apparatus (for example, a camera), an archive containing previously captured data, a feed interface configured to receive data from a content provider, a computer graphics system configured to generate data, or a combination of these sources. The video encoding apparatus 13 encodes data from the data source 11 and outputs the encoded data to the output interface 15. The output interface 15 may include at least one of a regulator, a modem, or a transmitter. The decoding-side apparatus 2 includes an input interface 21, a video decoding apparatus 23, and a display apparatus 25. The input interface 21 includes at least one of a receiver or a modem. The input interface 21 may receive the bitstream from the storage apparatus via the link 3. The video decoding apparatus 23 decodes the received bitstream. The display apparatus 25 is configured to display the decoded data. The display apparatus 25 may be integrated with or separate from another component of the decoding-side apparatus 2. The display apparatus 25 is optional for the decoding side. In another example, the decoding side may include another apparatus or device to which the decoded data is applied.

According to the video coding system shown in FIG. 1A, various video coding methods may be used to compress and decompress a video.

FIG. 1B is a block diagram of an exemplary video encoding apparatus applicable to an embodiment of this application. As shown in the figure, the video encoding apparatus 1000 includes a prediction unit 1100, a partitioning unit 1101, a residual generation unit 1102 (represented by a circle with a plus symbol inside, behind the partitioning unit 1101 in FIG. 1B), a transform processing unit 1104, a quantization unit 1106, a dequantization unit 1108, an inverse transform processing unit 1110, a reconstruction unit 1112 (represented by a circle with a plus symbol inside, behind the inverse transform processing unit 1110 in FIG. 1B), a filter unit 1113, a decoded image buffer 1114, and an entropy encoding unit 1115. The prediction unit 1100 includes an inter prediction unit 1121 and an intra prediction unit 1126. The decoded image buffer 1114 may also be referred to as an already-decoded image buffer, a decoded picture buffer, an already-decoded picture buffer, or the like. The video encoder 20 may alternatively include more, fewer, or different function components than those shown in this example. For example, in some cases, the transform processing unit 1104, the inverse transform processing unit 1110, and the like may not be included.

The partitioning unit 1101 cooperates with the prediction unit 1100 to partition received video data into slices, coding tree units (CTU), or other larger units. The video data received by the partitioning unit 1101 may be a video sequence that includes video frames such as I-frames, P-frames, or B-frames.

The prediction unit 1100 may partition a CTU into coding units (CU) and perform intra prediction encoding or inter prediction encoding on the CUs. To perform intra prediction and inter prediction on a CU, the CU may be partitioned into one or more prediction units (PU).

The inter prediction unit 1121 may perform inter prediction on a PU to generate predicted data for the PU. The predicted data includes a predicted block for the PU, motion information of the PU, and various syntax elements. The inter prediction unit 1121 may include a motion estimation (ME) unit and a motion compensation (MC) unit. The motion estimation unit may be configured to perform motion estimation to generate a motion vector, and the motion compensation unit may be configured to obtain or generate a predicted block based on the motion vector.

The intra prediction unit 1126 may perform intra prediction on the PU to generate predicted data for the PU. The predicted data for the PU may include a predicted block for the PU and various syntax elements.

The residual generation unit 1102 may generate a residual block for the CU by subtracting the predicted block for the PU, obtained by partitioning the CU, from an original block of the CU.

The transform processing unit 1104 may partition the CU into one or more transform units (TU), and partitioning of prediction units may be different from that of transform units. A residual block associated with a TU is a sub-block obtained by partitioning the residual block for the CU. A coefficient block associated with a TU is generated by applying one or more transforms on a residual block associated with the TU.

The quantization unit 1106 may quantize a coefficient in the coefficient block based on a selected quantization parameter, and may adjust a degree of quantization of the coefficient block by adjusting the quantization parameter (QP).

The dequantization unit 1108 and the inverse transform processing unit 1110 may respectively apply dequantization and inverse transform to the coefficient block to obtain a reconstructed residual block associated with the TU.

The reconstruction unit 1112 may add the predicted block generated by the prediction unit 1100 and the reconstructed residual block, to generate a reconstructed image.

The filter unit 1113 performs in-loop filtering on the reconstructed image and stores the filtered reconstructed image in the decoded image buffer 1114 as a reference image. The intra prediction unit 1126 may extract a reference image of a block adjacent to the PU from the decoded image buffer 1114 to perform intra prediction. The inter prediction unit 1121 may perform inter prediction on a PU of an image of a current frame by using a reference image of a previous frame buffered in the decoded image buffer 1114.

The entropy encoding unit 1115 may perform an entropy encoding operation on the received data (such as a syntax element, a quantized coefficient block, and motion information).

FIG. 1C is a block diagram of an exemplary video decoding apparatus applicable to an embodiment of this application. As shown in the figure, the video decoding apparatus 101 includes an entropy decoding unit 150, a prediction unit 152, a dequantization unit 154, an inverse transform processing unit 156, a reconstruction unit 158 (represented by a circle with a plus symbol inside, behind the inverse transform processing unit 155 in FIG. 1C), a filter unit 159, and a decoded image buffer 160. In another embodiment, the video decoder 30 may include more, fewer, or different function components. For example, in some cases, the inverse transform processing unit 155 may not be included.

The entropy decoding unit 150 may perform entropy decoding on a received bitstream, to extract a syntax element, a quantized coefficient block, motion information of a PU, and the like. The prediction unit 152, the dequantization unit 154, the inverse transform processing unit 156, the reconstruction unit 158, and the filter unit 159 may each perform corresponding operations based on a syntax element extracted from the bitstream.

The dequantization unit 154 may perform dequantization on a quantized coefficient block associated with a TU.

The inverse transform processing unit 156 may apply one or more inverse transforms on an inverse quantized coefficient block to generate a reconstructed residual block for the TU.

The prediction unit 152 includes an inter prediction unit 162 and an intra prediction unit 164. If intra prediction encoding is used for a PU, the intra prediction unit 164 may determine an intra prediction mode for the PU based on a syntax element decoded from the bitstream, and perform intra prediction based on the determined intra prediction mode and reconstructed reference information of a block adjacent to the PU that is obtained from the decoded image buffer 160, to generate a predicted block for the PU. If inter prediction encoding is used for a PU, the inter prediction unit 162 may determine one or more reference blocks for the PU based on motion information of the PU and a corresponding syntax element, and generate a predicted block for the PU based on the reference block obtained from the decoded image buffer 160.

The reconstruction unit 158 may obtain a reconstructed image based on the predicted block for the PU that is generated by the prediction unit 152 and the reconstructed residual block associated with the TU.

The filter unit 159 may perform in-loop filtering on the reconstructed image and store the filtered reconstructed image in the decoded image buffer 160. The decoded image buffer 160 may provide reference images for subsequent motion compensation, intra prediction, inter prediction, and the like, and may also output the filtered reconstructed image, as decoded video data, for display on the display apparatus.

By using the video encoding apparatus and the video decoding apparatus described above, the following basic coding process may be performed: on the encoding side, a frame of image is divided into blocks, intra prediction, inter prediction, or another algorithm is applied to a current block to generate a predicted block for the current block, a residual block is obtained by subtracting the predicted block from an original block of the current block, the residual block is transformed and quantized to obtain a quantized coefficient, and the quantized coefficient is entropy encoded to generate a bitstream; and on the decoding side, intra prediction or inter prediction is performed on the current block to generate a predicted block for the current block, the quantized coefficient obtained from the decoded bitstream is dequantized and inverse-transformed to obtain a residual block, the predicted block and the residual block are added to obtain a reconstructed block, reconstructed blocks form a reconstructed image, and the reconstructed image is in-loop filtered in images or blocks to obtain a decoded image. The decoding side performs similar operations as the encoding side to obtain the decoded image, and the decoded image obtained on the decoding side is generally referred to as a reconstructed image. The decoded image may function as a reference frame for performing inter prediction on a subsequent frame. Block partitioning information determined on the encoding side, prediction, transform, quantization, entropy encoding, in-loop filtering, and other mode information and parameter information may be written into the bitstream if needed. The decoding side determines the same block partitioning information, prediction, transform, quantization, entropy encoding, in-loop filtering, and other mode information and parameter information as the encoding side by decoding the bitstream or analyzing available information, thereby ensuring that an original image inputted to the encoding side is the same as the decoded image obtained on the decoding side.

Although a block-based hybrid encoding framework is used as an example above, embodiments of this application are not limited thereto. With the development of technologies, one or more modules in the framework, and one or more steps in the process, may be replaced or optimized.

Herein, the current block may refer to a block-level coding unit, such as a current encoding unit (current CU) or a current prediction unit (current PU) in a current image.

During intra prediction performed by the encoding side, a current block is predicted by using generally various angular modes and non-angular modes to obtain a predicted block. Based on rate-distortion information calculated from the predicted block and an original block, an optimal intra prediction mode is selected for the current block, and the intra prediction mode is encoded and transmitted to the decoding side via a bitstream. The intra prediction mode selected for the current block is obtained by decoding on the decoding side, and intra prediction is performed on the current block in the intra prediction mode. Herein, a reference line and an intra prediction mode that are selected for the current block are also referred to as a selected reference line and a selected intra prediction mode of the current block.

In VVC and ECM, in a plurality of conventional intra prediction modes, a current block is predicted using reconstructed information of blocks around the current block. The conventional intra prediction modes include a planar mode (that is, Planar mode, with a mode index of 0), a DC mode (that is, DC mode, with a mode index of 1), and 65 angular prediction modes (with mode indexes ranging from 2 to 66). FIG. 2 shows angular directions for angular prediction modes with mode indexes ranging from 2 to 66. Herein, the angular prediction mode is also referred to as an angular mode.

Since rectangular predicted blocks are introduced in VVC, for these rectangular blocks, angular directions for some of the angular modes with indexes ranging from 2 to 66 are replaced with wider angular directions. As shown in FIG. 2, angular modes with indexes ranging from −14 to −1 and 67 to 80 are angular modes obtained by replacing with wider angles. These angular modes are unnecessary to be represented by flag bits when being selected. Instead, the angular modes are obtained based on a correspondence between a shape of a current block and a prediction mode index (2 to 66) selected for the current block. After matching of wide angular modes, each angular prediction mode predModeIntra (−14 to 80) has an angle value intraPredAngle, as shown in the table below. The angle value of the angular mode is used for subsequent angular prediction.

TABLE 1
Correspondence between an angular prediction mode and an angle value

| | | | | | | | | | | | | | | | | | |
|---|---|---|---|---|---|---|---|---|---|---|---|---|---|---|---|---|---|
| predModeIntra | −14 | −13 | −12 | −11 | −10 | −9 | −8 | −7 | −6 | −5 | −4 | −3 | −2 | −1 | 2 | 3 | 4 |
| intraPredAngle | 512 | 341 | 256 | 171 | 128 | 102 | 86 | 73 | 64 | 57 | 51 | 45 | 39 | 35 | 32 | 29 | 26 |
| predModeIntra | 5 | 6 | 7 | 8 | 9 | 10 | 11 | 12 | 13 | 14 | 15 | 16 | 17 | 18 | 19 | 20 | 21 |
| intraPredAngle | 23 | 20 | 18 | 16 | 14 | 12 | 10 | 8 | 6 | 4 | 3 | 2 | 1 | 0 | −1 | −2 | −3 |
| predModeIntra | 22 | 23 | 24 | 25 | 26 | 27 | 28 | 29 | 30 | 31 | 32 | 33 | 34 | 35 | 36 | 37 | 38 |
| intraPredAngle | −4 | −6 | −8 | −10 | −12 | −14 | −16 | −18 | −20 | −23 | −26 | −29 | −32 | −29 | −26 | −23 | −20 |
| predModeIntra | 39 | 40 | 41 | 42 | 43 | 44 | 45 | 46 | 47 | 48 | 49 | 50 | 51 | 52 | 53 | 54 | 55 |
| intraPredAngle | −18 | −16 | −14 | −12 | −10 | −8 | −6 | −4 | −3 | −2 | −1 | 0 | 1 | 2 | 3 | 4 | 6 |
| predModeIntra | 56 | 57 | 58 | 59 | 60 | 61 | 62 | 63 | 64 | 65 | 66 | 67 | 68 | 69 | 70 | 71 | 72 |
| intraPredAngle | 8 | 10 | 12 | 14 | 16 | 18 | 20 | 23 | 26 | 29 | 32 | 35 | 39 | 45 | 51 | 57 | 64 |
| predModeIntra | 73 | 74 | 75 | 76 | 77 | 78 | 79 | 80 | | | | | | | | | |
| intraPredAngle | 73 | 86 | 102 | 128 | 171 | 256 | 341 | 512 | | | | | | | | | |

Herein, each angular mode predModeIntra corresponds to one angle, and the angle for each angular prediction mode is an angle of a lie segment, corresponding to the angular prediction mode, in the Cartesian coordinate system in FIG. 1. For example, for an angular mode with an index of 34, an angle value intraPredAngle is −32, and an angle is −45°, 45°, or 135°, which is related to a direction represented by 0° defined in the Cartesian coordinate system.

The intra prediction mode described herein, unless otherwise specified, refers to a conventional intra prediction mode including the planar mode, the DC mode, and the angular mode.

According to statistical properties, a pixel region that is closer to the current block is more likely to share a same intra prediction mode as the current block. According to this property, the most probable mode (MPM) technique is adopted in HEVC, VVC, and the enhanced compression model (ECM). The ECM is reference software that is based on the VTM-10.0 and integrates various new tools, to further explore coding performance.

According to the MPM, an MPM list is constructed first. The MPM list is filled with six intra prediction modes that are most likely to be selected for the current block. If an intra prediction mode selected for the current block is in the MPM list, only an index (requiring only three bits) of the intra prediction mode needs to be encoded. If an intra prediction mode selected for the current block is not in the MPM list but is instead in 61 non-MPM modes, the intra prediction mode is encoded using truncated binary code (TBC) in the entropy encoding stage.

In VVC, regardless of whether multiple reference lines (MRL) and intra sub-partitions (ISP) are applied, the MPM list always contains six prediction modes. In ECM, MPM is divided into MPM and secondary MPM. MPM and secondary MPM use lists with lengths of 6 and 16, respectively. In the six modes in the MPM list, the first position in the MPM list is always filled with the planar mode. The remaining five positions are filled sequentially according to a set procedure until all the five positions are filled. Additional modes are automatically grouped into the secondary MPM. The secondary MPM list may consist of some main angular modes other than the intra prediction modes in the MPM list. Since an MPM flag is coded after the MRL mode, the coding of the MPM in the ECM depends on an MRL flag bit. When the MRL mode is not to be used for the current block, the MPM flag needs to be decoded to determine whether MPM is to be used for the current block. When the MRL mode is to be used for the current block, it is unnecessary to decode the MPM flag, and it is determined by default that the MPM is to be used for the current block.

Template based intra mode derivation (TIMD) and decoder-side intra mode derivation (DIMD) are two intra prediction techniques for luma frames that have been incorporated into the ECM reference software. According to the two techniques, the decoding side derives an intra prediction mode for the current block based on reconstructed pixel values around the current block, thereby reducing a quantity of bits for encoding an index of the intra prediction mode.

In ECM, as shown in FIG. 4, a left adjacent region and an upper adjacent region of a current block (for example, a current CU) 11 constitute template regions 12 of the current block. The left adjacent region is referred to as a left template region (which is referred to as a left template for short), and the upper adjacent region is referred to as an upper template region or an upper-side template region (which is referred to as an upper template for short). Template reference (reference of the template) regions 13 are arranged on outer sides (a left side and an upper side) of the template regions 12. Exemplary sizes and locations of the regions are shown in FIG. 4. In an example, a width L1 of the left template and a height L2 of the upper template are both 4. The template reference region 13 may be a row arranged adjacent to and above the template region or a column arranged adjacent to and on the left of the template region.

In TIMD, it is assumed that distribution characteristics of the current block are consistent with distribution characteristics of the template regions of the current block. Reconstructed values for the template reference regions are used as reconstructed values for a reference line. Then, the template regions are predicted by traversing all the intra prediction modes in the MPM and secondary MPM, to obtain prediction results. Next, a sum of absolute transformed differences (SATD) between the reconstructed values for the template regions and prediction results (predicted values for the template regions) for each of the modes is calculated, and the TIMD mode for the current block is determined. The TIMD mode is derived in the same way on the decoding side. If TIMD is allowed to be used for the sequence, and an intra prediction mode selected for the current block is the TIMD mode, only one flag bit is required to indicate that the current block is to be predicted using the TIMD mode. Decoding of a remaining syntax element related to intra prediction such as ISP and MPM may be skipped, thereby greatly reducing encoding bits.

After the SATD between the reconstructed values for the template regions and the prediction results for each mode is obtained, the TIMD mode can be determined in the following manner. It is assumed that mode1 and mode2 are two angular modes used for intra prediction in MPM, mode1 is an angular mode with the smallest SATD, and SATD of mode1 is cost1; mode2 is an angular mode with the second smallest SATD, and SATD of mode2 is cost2.
When cost1×2≤cost2, mode1 serves as the TIMD mode for the current block.
When cost1×2>cost2, a prediction mode obtained by performing weighting on mode1 and mode2 serves as the TIMD mode for the current block, and is also referred to as a TIMD fusion mode.

In DIMD, reconstructed pixel values around the current block serve as a template. Each 3×3 region of the template is scanned using a sobel operator to calculate gradients in a horizontal direction and a vertical direction. Based on the gradients Dx and Dy respectively obtained in the horizontal direction and the vertical direction, an amplitude value for each location is calculated according to Amp=abs(Dx)+abs(Dy), and an angle value for each location is calculated according to angular=arctan(Dy/Dx). An angle value for each location in the template is mapped to a conventional angular mode, and amplitude values of the same angular mode are accumulated to obtain a histogram of amplitude values and angular modes. In a case in which there are two angular modes respectively with the highest amplitude value and the second-highest amplitude value, weighting is performed on predicted values for the two angular modes respectively with the highest amplitude value and the second-highest amplitude value, as well as a predicted value for the planar mode, to obtain a final prediction result for the current block when the DIMD is used. In this case, the prediction mode integrates three intra prediction modes: the planar mode, as well as the two angular modes respectively with the highest amplitude value and the second-highest amplitude value. Herein, this mode is called a DIMD fusion mode. In a case in which there are no angular modes respectively with the highest amplitude value and the second-highest amplitude value, prediction using the DIMD is equivalent to prediction using the planar mode.

In HEVC, in intra prediction, an upper row and a left column that are closest to the current block are used as a reference line for prediction. If there is a significant difference between an original pixel value and reconstructed values for the upper row and the left column, prediction quality of the current block may be affected significantly. To resolve this problem, the MRL technique is adopted in VVC, in which not only a reference line with an index of 0 (Reference line 0) is used, but also a reference line with an index of 1 (Reference line 1) and a reference line with an index of 2 (Reference line 2) serve as extended reference lines for intra prediction. To reduce encoding complexity, MRL is used only for non-planar modes in MPM. On the encoding side, during prediction of the current block using each angular mode, all the three reference lines are compared with each other, and a reference line with a minimum rate-distortion cost (RD Cost) is selected. An index of the finally selected reference line is encoded and transmitted to the decoding side. On the decoding side, the index of the reference line is decoded, and based on the index of the reference line, the reference line selected for the current block is determined for predicting the current block.

FIG. 5 shows four reference lines for the current block, which are a reference line 221 with an index of 0 (reference line 0), a reference line 222 with an index of 1 (reference line 1), a reference line 223 with an index of 2 (reference line 2), and a reference line 224 with an index of 3 (reference line 3), respectively. There may be more reference lines for the current block, and only some of reconstructed values for the reference lines may be used during prediction.

In ECM, more reference lines may be used for the MRL mode, and indexes of a plurality of candidate reference lines are filled in a list. The list is called an MRL index list, an MRL list, a candidate reference line list, a reference line index list, or the like. In a case in which TIMD is not used for the current block, a length of an MRL index list is 6, and the MRL index list may be filled with indexes of six reference lines. The indexes of the six reference lines maintain unchanged and are arranged in a fixed order: 0, 1, 3, 5, 7, 12. The first location is filled with an index. In a case in which MRL is used, a location of a reference line selected for the current block in the MRL index list is represented by encoding an MRL index. An MRL index list {0, 1, 3, 5, 7, 12} is used as an example, in which indexes 0, 1, 3, 5, 7, and 12 in the list correspond to MRL indexes 0, 1, 2, 3, 4, and 5, respectively. The MRL index may be encoded using unary truncated code based on a context model, to generate a binary identity based on the context model. The binary identity may also be called a binary flag bit, a binary symbol, a binary digit, or the like. A smaller value of an MRL index indicates a shorter code length and faster decoding.

In a case in which both the MRL mode and the TIMD mode are used, a length of an MRL index list is 3, the MRL index list may be filled with indexes of three reference lines, and the indexes are arranged in a fixed order, shown by {0, 1, 3}.

Herein, although a reference line is called a “line”, it is only for convenience of expression. A reference line actually includes a row and a column. Generally, reconstructed values for a reference line that are used for prediction also include reconstructed values for both a row and a column, which is consistent with common expression in the art.

In different standards, the same technique may have different names. For example, the technique of deriving a list of most probable modes using blocks around a current block, similar to MPM, is called adaptive intra mode coding (AIMC) in AV2 (AVM), and is called frequency-based intra mode coding (FIMC) in the case of screen content encoding in AVS3. In the case of non-screen content encoding, techniques similar to MPM are generally enabled. The technique of performing intra prediction using multiple reference lines, similar to MRL, is called multiple reference line selection for intra prediction (MRLS: Multiple reference line selection for intra prediction) in AV2 (AVM). This is merely a difference in names. When terms such as MPM and MRL are used in embodiments, they should also cover the essentially identical techniques in other standards.

An embodiment provides an intra prediction fusion (IPF) technique. According to IPF, two reference lines and an angular mode selected for a current block form two combinations of the reference lines and the intra prediction mode. The current block is predicted using the two combinations to obtain two prediction results, and the two prediction results are weighted to serve as a final prediction result for the current block, as follows:

p_{fusion}=wₐ×pₐ+w_{b}×p_{b}

pₐ denotes a result of predicting the current block using a combination of a reference line with an index of a and the angular mode, p_{b} denotes a result of predicting the current block using a combination of a reference line with an index of b and the angular mode, p_{fusion} denotes a fused prediction result for the current block. wₐ denotes a weight assigned to pₐ during weighting, and w_{b} denotes a weight assigned to p_{b} during weighting. In an example, b=a+1, wₐ is ¾, and w_{b} is ¼. When the IPF is used for the current block, the fused prediction result mentioned above serves as the final prediction result for the current block, that is, a predicted value for the current block.

In an example, IPF is enabled by default for angular modes selected for the current block when the following conditions are met: an angular mode selected for the current block is not an angular mode of an integer slope; a product of a width and a height of the current block is greater than 16; and the intra sub-partitions ISP mode is not selected for the current block. In a case that a remainder generated after an angle value (intraPredAngle) of an angular mode divided by 32 is 0, the angular mode is an angular mode of an integer slope (integer slope). For a correspondence between intraPredAngle and an angular mode, reference may be made to Table 1 above. In another example, other restrictions such as a quantity of modes may be added for the IPF. For example, IPF is not allowed to be used if using IPF causes three or more intra prediction modes to be fused for predicting the current block, or using IPF causes two or more angular modes to be fused for predicting the current block.

An embodiment provides a template-based multiple reference line & intra intra prediction mode, abbreviated as TMRL mode. The TMRL mode is an intra prediction mode in which a candidate list is constructed based on a combination of an extended reference line and an intra prediction mode, and the combination of the extended reference line and the intra prediction mode is encoded and decoded. The combination coding method of the TMRL mode can reduce encoding costs and improve encoding performance.

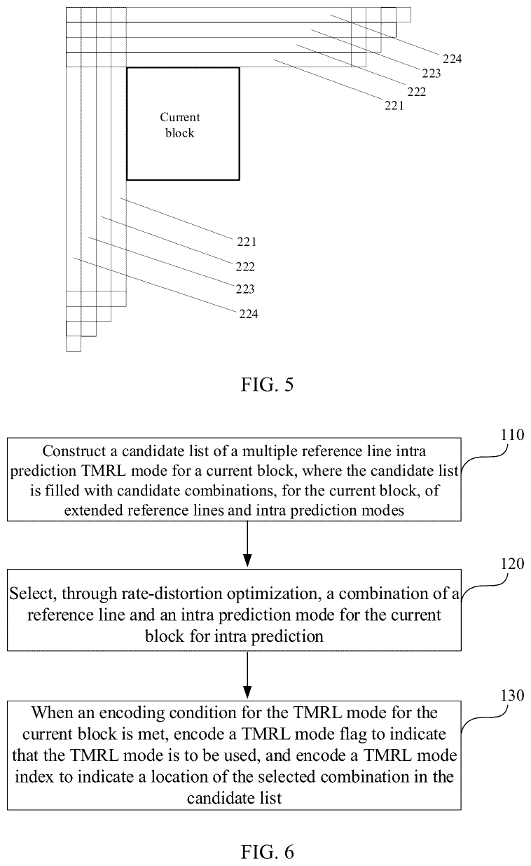

The video encoding method in embodiments is applied to an encoder. As shown in FIG. 6, the method includes the following steps 110 to 130.

In step 110, a candidate list of the TMRL mode for the current block is constructed, where the candidate list is filled with candidate combinations, for the current block, of extended reference lines and intra prediction modes.

In step 120, through rate-distortion optimization, one combination of a reference line and an intra prediction mode for the current block is selected for intra prediction.

Herein, the reference lines include a reference line with an index of 0 and an extended reference line. The combination, selected for the current block, of a reference line and an intra prediction mode may be a combination of the reference line with the index of 0 and an intra prediction mode, or may be a combination of the extended reference line and an intra prediction mode.

In step 130, when an encoding condition for the TMRL mode for the current block is met, a TMRL mode flag for the current block is encoded to indicate that the TMRL mode is to be used for the current block, and a TMRL mode index for the current block is encoded to indicate a location of the selected combination in the candidate list.

The encoding condition includes: the selected combination being in the candidate list (in this case, the extended reference line is selected for the current block), and may further include any one or more of following: condition 1: the current block being a block in a luma frame, that is, the TMRL mode is only used for luma frames; condition 2: the current block being not located at an upper boundary of a coding tree unit CTU; condition 3: MRL being allowed to be used for a sequence where the current block is located; condition 4: a size of the current block meeting a size requirement when the TMRL mode is used; or condition 5: a length-width ratio of the current block meeting a length-width ratio requirement for the current block when the TMRL mode is used. The Golomb-Rice encoding method may be used for the TMRL mode index. Candidate combinations may be classified more appropriately according to different codeword lengths for encoding and decoding, thereby improving encoding efficiency.

In a case in which the TMRL mode is to be used for the current block, the MPM mode, the intra sub-partitions ISP mode, the multiple transform selection MTS mode, and the low-frequency non-separable transform LFNST mode may be skipped. The TMRL mode flag and the TMRL mode index may represent the reference line and the intra prediction mode selected for the current block, without encoding and decoding MPM-related syntax elements.

Herein, the candidate list is filled with candidate combinations, selected for the current block, of extended reference lines and an intra prediction mode, which indicates that the combinations in the candidate list need to participate in the rate-distortion optimization for the current block. That is, a prediction mode for the current block is selected based on rate-distortion costs.

In an example of this embodiment, when TIMD is used for the current block, the encoding of the TMRL mode flag and the TMRL mode index for the current block is skipped. When TIMD is not used for the current block and a selected combination is not in the candidate list, the TMRL mode flag for the current block is encoded to indicate that the TMRL mode is not used, and the encoding of the TMRL mode index is skipped. When TIMD is not used for the current block, the original MRL index may be replaced with the TMRL mode flag and the TMRL mode index provided in this embodiment.

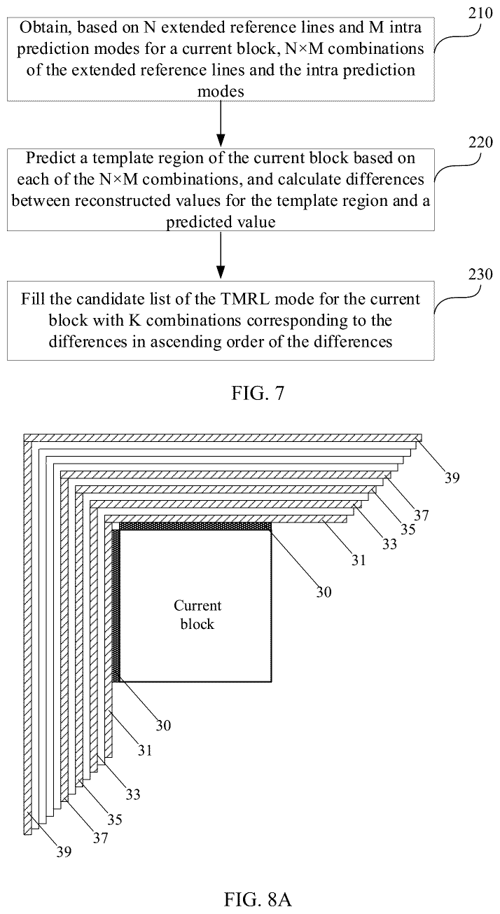

An embodiment provides a method for constructing a candidate list of a TMRL mode, which may be applied to an encoder, and may also be applied to a decoder. As shown in FIG. 7, the method includes the following steps 210 to 230.

In step 210, based on N extended reference lines and M intra prediction modes for the current block, N×M combinations of the extended reference lines and the intra prediction modes are obtained, where N≥1, M≥1 and N×M≥2.

In step 220, a template region of the current block is predicted using each of the N×M combinations, and differences between reconstructed values for the template region and the predicted value obtained by prediction are calculated.

In this step, in addition to the SATD and the sum of absolute difference (SAD), the difference may be represented by a sum of squared difference (SSD), a mean absolute difference (MAD), a mean squared error (MSE: Mean Squared Error), or the like.

In step 230, the candidate list of the TMRL mode for the current block is filled with K combinations corresponding to differences in ascending order of the differences, where 1≤K≤N×M.

The candidate list created in this embodiment can achieve combined encoding of an extended reference line and an intra prediction mode, thereby improving encoding efficiency. A combination with a higher probability of being selected is arranged at front of the candidate list, leading to a smaller TMRL mode index for the selected combination during encoding, thereby reducing encoding costs.

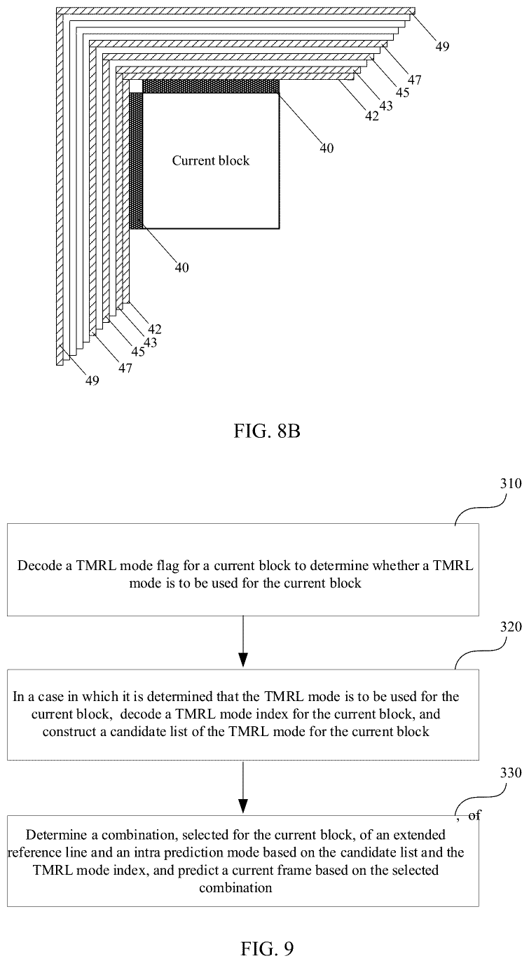

The template region of the current block may be arranged on one or more reference lines that are closest to the current block. The N extended reference lines participating in the combination are extended reference lines located outside of the template region and do not exceed the boundary of the CTU. In an example, to construct the candidate list of the TMRL mode, all extended reference lines that do not exceed the boundary of the CTU are selected from predefined extended reference lines with indexes {1, 3, 5, 7, 12}, where N≤5. The template regions of the current block are arranged on a reference line with an index of 0 (that is, the reference line with the index of 0 is called a reference line where the template regions are located), and other reference lines are called reference lines outside the template regions. FIG. 8A shows five extended reference lines participating in the combination: a reference line 31 with an index of 1, a reference line 33 with an index of 3, a reference line 35 with an index of 5, a reference line 37 with an index of 7, and a reference line 39 with an index of 12. In another example shown in FIG. 8B, template regions 40 of the current block are arranged on two reference lines with indexes of 0 and 1. Extended reference lines participating in the combination are all extended reference lines, that do not exceed the boundary of the CTU, among a reference line 42 with an index of 2, a reference line 43 with an index of 3, a reference line 45 with an index of 5, a reference line 47 with an index of 7, and a reference line 49 with an index of 12.

In an example of this embodiment, the M intra prediction modes participating in the combination are allowed to be selected from only angular modes, or selected from both angular modes and DC modes, or selected from angular modes, DC modes, and planar modes. The intra prediction modes may be selected from MPM, or may be selected among intra prediction modes selected from MPM and secondary MPM, or may be selected step by step according to predetermined rules.

An embodiment provides a TMRL mode-related video decoding method, applied to a decoder. As shown in FIG. 9, the method includes the following steps 310 and 330.

In step 310, a multiple reference line intra prediction TMRL mode flag for the current block is decoded to determine whether the TMRL mode is to be used for the current block.

In step 320, in a case in which it is determined that the TMRL mode is to be used for the current block, the TMRL mode index for the current block is decoded, and a candidate list of the TMRL mode for the current block is constructed, where the candidate list is filled with candidate combinations, for the current block, of extended reference lines and intra prediction modes.

In step 330, based on the candidate list and the TMRL mode index, a combination, selected for the current block, of an extended reference line and an intra prediction mode is determined, and a current frame is predicted based on the selected combination, where the TMRL mode index is used to represent a location, in the candidate list, of the selected combination of the extended reference line and the intra prediction mode.

In this embodiment, both the extended reference line and the intra prediction mode that are selected for the current block may be represented by the TMRL mode index, without using two indexes, thereby reducing encoding costs. In a case in which it is determined, based on the TMRL mode flag, that the TMRL mode is to be used for the current block, the decoding of syntax elements related to the MPM mode, the ISP mode, the MTS mode, and the LFNST mode may be skipped.

In an example of this embodiment, the video decoding method includes the following steps 1 to 3.

In step 1, the decoder decodes a syntax element related to the TMRL mode, and syntax elements related to the TIMD mode, the MRL mode, and the like.

Syntax related to decoding of the current block is shown in the table below:

| | Descriptor |
|---|---|
| coding_unit( x0, y0, cbWidth, cbHeight, cqtDepth, treeType, modeType ) { | |
| ... ... | |
| if( pred_mode_plt_flag ) | |
| palette_coding( x0, y0, cbWidth, cbHeight, treeType ) | |
| else { | |
| if( sps_bdpcm_enabled_flag && | |
| cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| else { | |
| if( sps_mip_enabled_flag ) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else { | |
| if( sps_timd_enable_flag && cbWidth * cbHeight <= 1024 ) | |
| intra_timd_flag | ae(v) |
| if( sps_mrl_enabled_flag && ( ( y0 % CtbSizeY ) > 0 ) && !intra_timd_flag ) | |
| cu_tmrl_flag | ae(v) |
| if(cu_tmrl_flag ) | |
| tmrl_idx | ae(v) |
| if( sps_mrl_enabled_flag && ( ( y0 % CtbSizeY ) > 0 ) && intra_timd_flag ) | |
| intra_luma_ref_idx | ae(v) |
| if( sps_isp_enabled_flag && intra_luma_ref_idx = = 0 && | |
| ( cbWidth <= MaxTbSizeY && cbHeight <= MaxTbSizeY ) && | |
| ( cbWidth * cbHeight > MinTbSizeY * MinTbSizeY ) && | |
| !cu_act_enabled_flag && !cu_tmrl_flag) | |
| intra_subpartitions_mode_flag | ae(v) |
| if( intra_subpartitions_mode_flag = = 1 ) | |
| intra_subpartitions_split_flag | ae(v) |
| if( !intra_timd_mode &&!cu_tmrl_flag ){ | |
| if( intra_luma_ref_idx == 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx == 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainder[ x0 ][ y0 ] | ae(v) |
| } | |
| } | |
| } | |
| } | |
| } | |
| ... ... | |

“cu_tmrl_flag” in the table represents the TMRL mode flag. A value of 1 for “cu_tmrl_flag” indicates that the TMRL mode is to be used for the current block, that is, it is defined that an intra prediction mode for a current luma sample is the TMRL mode. A value of 0 for “cu_tmrl_flag” indicates that the TMRL mode is not to be used for the current block, that is, it is defined that an intra prediction mode for a current luma sample is not the TMRL mode. “tmrl_idx” in the table represents the TMRL mode index, which represents a location, in the candidate list of the TMRL mode, of a combination of an extended reference line and an intra prediction mode that is selected for the current block. In other words, an index of the selected combination in the sorted candidate list of the TMRL mode is defined (representing an index of the location of the combination).

The TMRL mode may be considered as an evolution of the MRL mode, or may be considered as a constituent part of the MRL mode. In this example, in a case in which the TIMD mode is to be used for the current block, it is unnecessary to decode a syntax element of the MRL mode. In a case in which the TIMD mode is not to be used for the current block, it needs to decode a syntax element of the TMRL mode. As shown in the table above, before cu_tmrl_flag is decoded, it is determined first whether the following conditions are met: MRL is allowed to be used for the current block (that is, whether sps_mrl_enabled_flag equals to 1), the current block is not located at an upper boundary of the CTU (that is, whether (y0% CtbSizeY)>0, and the TIMD is not to be used for the current block. When these conditions are met, cu_tmrl_flag is decoded. If the first two conditions among the above conditions are met and the TIMD is to be used for the current block, the multiple reference line index intra_luma_ref_idx for the current block is decoded.

In step 2, if the TMRL mode is to be used for the current block, a candidate list of the TMRL mode is constructed, where the construction of the candidate list of the TMRL mode is an operation that needs to be performed by both the encoder and the decoder.

A candidate extended reference line is determined. The candidate extended reference line is selected from predefined extended reference lines. Which of the predefined extended reference lines may be used is determined based on a location of the current block in an image. In this example, the template is created on the reference line with the index of 0, where N=5. All extended reference lines that do not exceed the boundary of the CTU among the extended reference lines with the indexes of {1, 3, 5, 7, 12} are determined as the candidate extended reference lines.

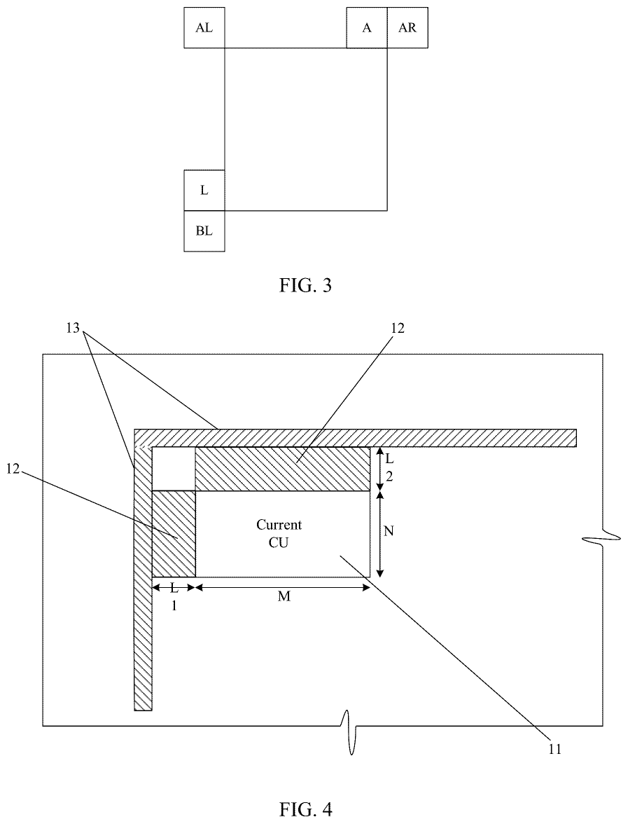

A candidate intra prediction mode is determined. In this example, M=6, that is, a quantity of candidate intra prediction modes is 6. First, in 67 conventional prediction modes, the planar mode and the DC mode are removed, or only the planar mode is removed while the DC mode is reserved, and then six intra prediction modes to participate in the combination are selected step by step. In a first step, non-repeating intra prediction modes are sequentially selected from intra prediction modes used for predicted blocks at five locations adjacent to the current block, as shown in FIG. 3. In a second step, an expansion operation is performed on angular modes selected in the first step. A plus-one and minus-one operation is performed sequentially on each angular mode, and non-repeating angular modes obtained by expansion are selected, until a quantity of selected modes is 6. In a case that a quantity of selected intra prediction modes does not reach 6 after the expansion operation, or no angular mode is selected in the first step, a third step is performed: non-repeating modes are selected from a predefined mode set, until a quantity of selected modes is 6.

A candidate list of the TMRL mode is constructed. After a candidate extended reference line and a candidate intra prediction mode are determined, all combinations of extended reference lines from an extended reference line list and TMRL modes from the candidate list are compared one by one. The template region on row where the reference line 0 is located is predicted using each of these combinations to calculate differences between reconstructed values for the template region and a predicted value obtained by prediction for each combination, and the candidate list of the TMRL mode is filled with K combinations having the smallest differences in ascending order of the differences. In this example, K=12.

In a third step, a combination, selected for the current block, of an extended reference line and an intra prediction mode is determined based on the constructed candidate list of the TMRL mode and the decoded TMRL mode index, and intra prediction is performed on the current block based on the selected combination. When the TMRL mode is to be used for the current block, an index refIdx of a reference line (which is an extended reference line in this case) and an intra prediction mode (represented by a variable predModeIntra) that are selected for the current block are included in the determined combination.

Codewords may be saved using the TMRL mode. However, the template-based technique generally increases complexity of the decoder. In addition, using the TMRL mode means that the encoder and the decoder are required to support the complex calculations, and not all encoders and decoders support these calculations. Based on this, whether the TMRL mode is to be used may be represented by a higher-layer syntax element, thereby achieving more flexible selection of video coding modes and thus achieving better adaptability.

The higher-layer syntax element herein refers to a syntax element at sequence, image, or slice levels that imposes constraints on block-level intra prediction syntax elements.

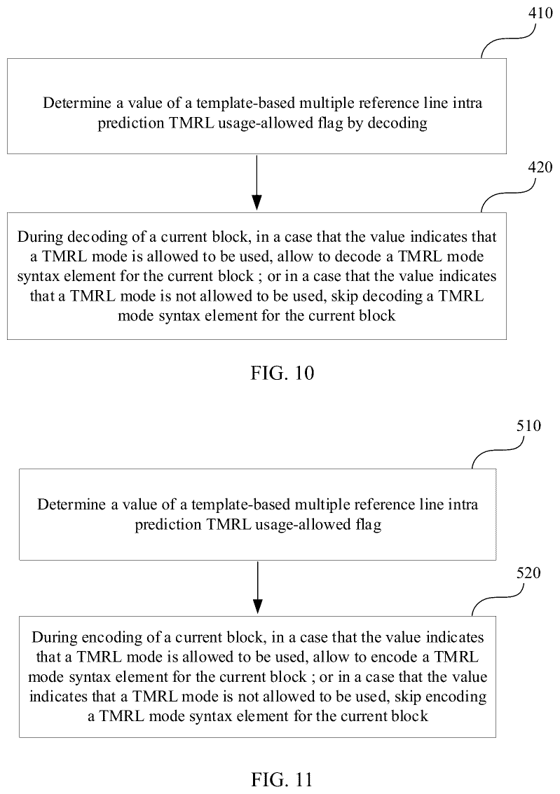

An embodiment of this application provides a video decoding method, in which the usage of the TMRL mode is controlled through higher-layer syntax. As shown in FIG. 10, the video decoding method in this embodiment includes the following steps 410 and 420.

In step 410, a value of a TMRL enabled flag is determined by decoding. The TMRL enabled flag is used to indicate whether the TMRL mode is allowed to be used.

In this step, the value of the TMRL enabled flag is determined by decoding. The value of the TMRL enabled flag may be determined by decoding the TMRL enabled flag, or the value of the TMRL enabled flag may be determined by decoding other syntax elements related to the TMRL, or the value of the TMRL enabled flag may be determined by decoding other syntax elements related to the TMRL and the TMRL enabled flag.

In step 420, during decoding of a current block: in a case in which the value of the TMRL enabled flag indicates that a TMRL mode is allowed to be used, it is allowed to decode a TMRL mode syntax element for the current block; or in a case in which the value of the TMRL enabled flag indicates that a TMRL mode is not allowed to be used, decoding of a TMRL mode syntax element for the current block is skipped.

For an identifier such as the TMRL enabled flag, the MRL enabled flag, or the template enabled flag, a value 0 of the identifier generally indicates that the corresponding mode is not allowed to be used, and a value 1 of the identifier indicates that the corresponding mode is allowed to be used. However, this application is not limited thereto. Alternatively, a value 1 indicates that the mode is not allowed to be used, and a value 0 indicates that the mode is allowed to be used.

In this embodiment, the TMRL enabled flag is set to indicate whether the TMRL mode is allowed to be used, improving flexibility and adaptability of using the TMRL mode. Based on the value of the TMRL enabled flag, a TMRL mode syntax element for the current block can be correctly decoded.

In an exemplary embodiment of this application, the TMRL enabled flag is a sequence-level identifier. However, in another embodiment, the TMRL enabled flag may alternatively be an image-level identifier or a slice-level identifier.

In an exemplary embodiment of this application, the TMRL enabled flag may be decoded independently, without relying on other flags. In this case, the TMRL enabled flag is decoded to obtain the value of the TMRL enabled flag.

In standard text of VVC, to determine whether to enable the MRL mode (also referred to as an MRL technique or an MRL tool) for the current block, sps_mrl_enabled_flag is used to represent the sequence-level MRL enabled flag. Related syntax is shown in the table below.

### Sequence Parameter Set RBSP Syntax

| | Descriptor |
|---|---|
| seq_parameter_set_rbsp( ) { | |
| ... ... | |
| sps_mrl_enabled_flag | u(1) |
| ... ... | |
| } | |

A value 0 of sps_mrl_enabled_flag indicates that MRL is not allowed to be used, while a value 1 of sps_mrl_enabled_flag indicates that MRL is allowed to be used.

In this embodiment, the sequence-level TMRL enabled flag sps_tmrl_enabled_flag without depending on another flag is added, to control whether the TMRL mode is allowed to be used. Related syntax is shown in the table below.

### Sequence Parameter Set RBSP Syntax

| | Descriptor |
|---|---|
| seq_parameter_set_rbsp( ) { | |
| ... ... | |
| sps_mrl_enabled_flag | u(1) |
| sps_tmrl_enabled_flag | u(1) |
| ... ... | |
| } | |

In the table above, the TMRL enabled flag sps_tmrl_enabled_flag and the MRL enabled flag sps_mrl_enabled_flag are decoded independently from each other.

In an exemplary embodiment of this application, extended reference lines are used for the TMRL mode, and the reference line with the index of 0 is generally used during selection of an intra prediction mode. Therefore, when the TMRL mode is allowed to be used, intra prediction on the current block involves the usage of a plurality of reference lines. During design of higher-layer syntax, the decoding of the TMRL enabled flag may depend on the MRL enabled flag. In this case, the process of determining a value of a TMRL enabled flag by decoding includes: decoding an MRL enabled flag to obtain a value of the MRL enabled flag; and in a case in which the value of the MRL enabled flag indicates that MRL is not allowed to be used, skipping decoding the TMRL enabled flag, and determining, by default, the value of the TMRL enabled flag to a value indicating that the TMRL mode is not allowed to be used; or in a case in which the MRL enabled flag indicates that MRL is allowed to be used, decoding the TMRL enabled flag to obtain the value of the TMRL enabled flag.

In this embodiment, a sequence-level TMRL enabled flag depending on another flag is added, to control whether the TMRL mode is allowed to be used. Related syntax is shown in the table below.

### Sequence Parameter Set RBSP Syntax

| | Descriptor |
|---|---|
| seq_parameter_set_rbsp( ) { | |
| ... ... | |
| sps_mrl_enabled_flag | u(1) |
| if( sps_mrl_enabled_flag ) { | |
| sps_tmrl_enabled_flag | u(1) |
| } | |
| ... ... | |
| } | |

According to the table above, the MRL enabled flag sps_mrl_enabled_flag is first decoded during decoding. When the sequence-level sps_mrl_enabled_flag is 1, that is, it indicates that MRL is allowed to be used, the TMRL enabled flag sps_tmrl_enabled_flag is decoded to determine a value of sps_tmrl_enabled_flag.

In this embodiment, the TMRL enabled flag is a sequence-level identifier, and the MRL enabled flag is a sequence-level identifier. In another embodiment, the TMRL enabled flag may be an image-level identifier, and the MRL enabled flag may be a sequence-level identifier or an image-level identifier. In still another embodiment, the TMRL enabled flag is a slice-level identifier, and the MRL enabled flag may be a sequence-level identifier, an image-level identifier, or a slice-level identifier. In these embodiments, when the TMRL enabled flag and the MRL enabled flag are identifiers of a same level, the MRL enabled flag is decoded before the TMRL enabled flag.

In ECM, there are a plurality of template-based coding tools, such as DIMD, TIMD, and TMRL, all of which use templates as prediction tools. Alternatively, a unified identifier may be used to control all template-based techniques. For this, an embodiment of this application introduces a sequence-level identifier: a template enabled flag, which is represented by sps_tm_enabled_flag in an example. Herein, the template enabled flag is used to indicate whether a template is allowed to be used, that is, whether a template-based coding tool is allowed to be used. When a value of the template enabled flag indicates that the template is not allowed to be used, template-based coding tools such as DIMD, TIMD, and TMRL cannot be used.

In an exemplary embodiment of this application. In this embodiment, decoding of the TMRL enabled flag depends on the template enabled flag. The process of determining a value of a TMRL enabled flag by decoding includes: decoding a template enabled flag to obtain a value of the template enabled flag; and in a case in which the value of the template enabled flag indicates that a template is not allowed to be used, skipping decoding the TMRL enabled flag, and determining, by default, the value of the TMRL enabled flag to a value indicating that the TMRL mode is not allowed to be used; or in a case in which the template enabled flag indicates that a template is allowed to be used, decoding the TMRL enabled flag to obtain the value of the TMRL enabled flag.

In this embodiment, the sequence-level TMRL enabled flag depending on another flag is added, to control whether the TMRL mode is allowed to be used. Related syntax is shown in the table below.

### Sequence Parameter Set RBSP Syntax

| | Descriptor |
|---|---|
| seq_parameter_set_rbsp( ) { | |
| ... ... | |
| sps_tm_enabled_flag | u(1) |
| ... ... | |
| sps_mrl_enabled_flag | u(1) |
| if(sps_tm_enabled_flag) { | |
| sps_tmrl_enabled_flag | u(1) |
| } | |
| ... ... | |
| } | |

According to the table above, the template enabled flag sps_tm_enabled_flag is first decoded during decoding. When the sequence-level sps_tm_enabled_flag is 1, that is, it indicates that the template is allowed to be used, the TMRL enabled flag sps_tmrl_enabled_flag is decoded to determine a value of sps_tmrl_enabled_flag.

In this embodiment, the TMRL enabled flag is a sequence-level identifier, and the template enabled flag is a sequence-level identifier. In another embodiment, the TMRL enabled flag is an image-level identifier, and the template enabled flag may be a sequence-level identifier or an image-level identifier. In still another embodiment, the TMRL enabled flag is a slice-level identifier, and the template enabled flag may be a sequence-level identifier, an image-level identifier, or a slice-level identifier. In these embodiments, when the TMRL enabled flag and the template enabled flag are identifiers of a same level, the template enabled flag is decoded before the TMRL enabled flag.

In an exemplary embodiment of this application, the decoding of the TMRL enabled flag depends on the MRL enabled flag and the template enabled flag. The process of determining a value of a TMRL enabled flag by decoding includes: decoding an MRL enabled flag and a template enabled flag to obtain a value of the MRL enabled flag and a value of the template enabled flag; and in a case in which the value of the MRL enabled flag indicates that MRL is allowed to be used, and the value of the template enabled flag indicates that a template is allowed to be used, decoding the TMRL enabled flag to obtain the value of the TMRL enabled flag; or in a case in which the value of the MRL enabled flag indicates that MRL is not allowed to be used, or the value of the template enabled flag indicates that a template is not allowed to be used, skipping decoding the TMRL enabled flag, and determining, by default, the value of the TMRL enabled flag to a value indicating that the TMRL mode is not allowed to be used.

The dependency in this embodiment may be expressed in syntax shown in the table below.

### Sequence Parameter Set RBSP Syntax

| | Descriptor |
|---|---|
| seq_parameter_set_rbsp( ) { | |
| ... ... | |
| sps_tm_enabled_flag | u(1) |
| ... ... | |
| sps_mrl_enabled_flag | u(1) |
| if(sps_tm_enabled_flag && sps_mrl_enabled_flag) { | |
| sps_tmrl_enabled_flag | u(1) |
| } | |
| ... ... | |
| } | |

According to the table above, the template enabled flag sps_tm_enabled_flag and the MRL enabled flag sps_mrl_enabled_flag are first decoded during decoding. When both the sequence-level sps_tm_enabled_flag and sps_mrl_enabled_flag are 1, that is, it indicates that the template and MRL are allowed to be used, the TMRL enabled flag sps_tmrl_enabled_flag is decoded to determine a value of sps_tmrl_enabled_flag.

In this embodiment, the TMRL enabled flag is a sequence-level identifier, and the MRL enabled flag and the template enabled flag are sequence-level identifiers. In another embodiment, the TMRL enabled flag is an image-level identifier, and the MRL enabled flag and the template enabled flag may be sequence-level identifiers or image-level identifiers. In still another embodiment, the TMRL enabled flag is a slice-level identifier, and the MRL enabled flag and the template enabled flag may be sequence-level identifiers, image-level identifiers, or slice-level identifiers. In these embodiments, when the TMRL enabled flag, the MRL enabled flag, and the template enabled flag are identifiers of a same level, the MRL enabled flag and the template enabled flag are decoded before the TMRL enabled flag.

In ECM, there is a type of syntax element called general constraints information (GCI). The GCI includes a series of flag bits. These flag bits are used to indicate whether to restrict some sequence-level identifiers in the bitstream. In an example, when a specific flag bit in the GCI is greater than 0 (for example, equals to 1), it indicates that a sequence-level identifier corresponding to the flag bit in the bitstream is restricted and is unnecessary to be decoded. The sequence-level identifier is, for example, an identifier of a coding tool (such as the MRL, TMRL, DIMD, TIMD, or the like). However, a value 0 of the flag bit indicates that no restriction is applied to the sequence-level identifier corresponding to the flag bit in the bitstream, and it needs to decode the sequence-level identifier.

In an exemplary embodiment of this application, a flag bit set in the GCI indicates whether the TMRL mode is restricted. In this embodiment, the TMRL enabled flag is a sequence-level identifier, and the process of determining a value of a TMRL enabled flag by decoding includes: decoding GCI, and determining, based on a value of a flag bit used for indicating whether a TMRL mode is restricted in the GCI, whether the TMRL mode is restricted, and in a case in which the TMRL mode is restricted, skipping decoding the TMRL enabled flag, and determining that the value of the TMRL enabled flag is a value indicating that the TMRL mode is not allowed to be used; or in a case in which the TMRL mode is not restricted, decoding a sequence-level identifier to determine the value of the TMRL enabled flag.

In this embodiment, the sequence-level TMRL enabled flag sps_tmrl_enabled_flag is introduced. When the decoding of sps_tmrl_enabled_flag does not depend on the value of the sequence-level MRL enabled flag sps_mrl_enabled_flag, the GCI may be adjusted accordingly: a flag bit is added to indicate whether the TMRL mode is restricted, as shown in a syntax table below.

### GCI Syntax (General Constraints Information Syntax)

| | Descriptor |
|---|---|
| general_constraints_info( ) { | |
| gci_present_flag | u(1) |
| if( gci_present_flag ) { | |
| ... ... | |
| /* intra */ | |
| ... ... | |
| gci_no_mrl_constraint_flag | u(1) |
| gci_no_tmrl_constraint_flag | u(1) |
| ... ... | |
| /* inter */ | |
| ... ... | |
| /* transform, quantization, residual */ | |
| ... ... | |
| /* loop filter */ | |
| ... ... | |
| } | |
| while( !byte_aligned( ) ) | |
| gci_alignment_zero_bit | f(1) |
| } | |

As shown in the table above, in this embodiment, gci_no_tmrl_constraint_flag is added to indicate whether the TMRL mode is restricted, that is, whether the value of the TMRL enabled flag sps_tmrl_enabled_flag is restricted. When gci_no_tmrl_constraint_flag is 1, sps_tmrl_enabled_flag is unnecessary to be decoded, and sps_tmrl_enabled_flag defaults to 0, that is, it indicates that the TMRL mode is not allowed to be used. When gci_no_tmrl_constraint_flag is 0, it indicates that a value of sps_tmrl_enabled_flag is not restricted, and a related sequence-level identifier needs to be decoded to determine a value of sps_tmrl_enabled_flag.

gci_no_mrl_constraint_flag in the table above is used to indicate whether the MRL mode is restricted, that is, whether a value of the MRL enabled flag sps_mrl_enabled_flag is restricted. When gci_no_mrl_constraint_flag is 1, a value of sps_mrl_enabled_flag defaults to 0. When gci_no_mrl_constraint_flag is 0, it indicates that a value of sps_mrl_enabled_flag is not restricted, and the value of sps_mrl_enabled_flag can be determined by decoding.

In an exemplary embodiment of this application, a flag bit set in the GCI indicates whether the MRL mode is restricted. When the MRL mode is restricted, the TMRL mode is also restricted. In this embodiment, the TMRL enabled flag is a sequence-level identifier, and the process of determining a value of a TMRL enabled flag by decoding includes: decoding GCI, and determining, based on a value of a flag bit used for indicating whether MRL is restricted in the GCI, whether an MRL mode is restricted; and in a case in which the MRL mode is restricted, skipping decoding the TMRL enabled flag, and determining that the value of the TMRL enabled flag is a value indicating that the TMRL mode is not allowed to be used; or in a case in which the MRL mode is not restricted, decoding a sequence-level identifier to determine the value of the TMRL enabled flag.

Referring to the syntax table in the previous embodiment, in a case in which the decoding of the TMRL enabled flag sps_tmrl_enabled_flag depends on the value of the MRL enabled flag sps_mrl_enabled_flag, both whether the MRL mode is restricted and whether the TMRL mode is restricted are determined based on the flag bit gci_no_mrl_constraints_flag used for indicating whether the MRL mode is restricted in the GCI. When gci_no_mrl_constraints_flag is 1, sps_tmrl_enabled_flag defaults to 0, and sps_tmrl_enabled_flag is unnecessary to be decoded. When gci_no_mrl_constraints_flag is 0, a value of sps_tmrl_enabled_flag is determined by decoding a related sequence-level identifier.

In an exemplary embodiment of this application, a flag bit set in the GCI indicates whether usage of a template is restricted. When the usage of the template is restricted, a template-based tool (including the TMRL mode) is also restricted. In this embodiment, the TMRL enabled flag is a sequence-level identifier, and the process of determining a value of a TMRL enabled flag by decoding includes: decoding GCI, and determining, based on a value of a flag bit used for indicating whether usage of a template is restricted in the GCI, whether the usage of the template is restricted; and in a case in which the usage of the template is restricted, skipping decoding the TMRL enabled flag, and determining that the value of the TMRL enabled flag is a value indicating that the TMRL mode is not allowed to be used; or in a case in which the usage of the template is not restricted, decoding a sequence-level identifier to determine the value of the TMRL enabled flag.

In this embodiment, when the decoding of sps_tmrl_enabled_flag depends on the value of the sequence-level template enabled flag sps_tm_enabled_flag, both whether the usage of the template is restricted and whether the TMRL mode is restricted are determined based on gci_no_tm_constraints_flag, as shown by a syntax table below.

### General Constraints Information Syntax

| | Descriptor |
|---|---|
| general_constraints_info( ) { | |
| gci_present_flag | u(1) |
| if( gci_present_flag ) { | |
| gci_no_tm_constraint_flag | u(1) |
| ... ... | |
| } | |
| while( !byte_aligned( ) ) | |
| gci_alignment_zero_bit | f(1) |
| } | |

As shown in the table above, a flag bit gci_no_tm_constraints_flag set in the GCI indicates whether the MRL mode is restricted. When gci_no_tm_constraints_flag is 1, sps_tmrl_enabled_flag defaults to 0, and sps_tmrl_enabled_flag is unnecessary to be decoded. When gci_no_tm_constraints_flag is 0, a value of sps_tmrl_enabled_flag needs to be determined by decoding a related sequence-level identifier.

In an exemplary embodiment of this application, two flag bits set in the GCI indicate whether the MRL mode is restricted and whether the usage of the template is restricted, respectively. When the MRL mode is restricted or the usage of the template is restricted, the TMRL mode is also restricted. In this embodiment, the TMRL enabled flag is a sequence-level identifier, and the process of determining a value of a TMRL enabled flag by decoding includes: decoding GCI, and determining, based on a value of a flag bit used for indicating whether an MRL mode is restricted in the GCI, whether the MRL mode is restricted, and determining, based on a value of a flag bit used for indicating whether usage of a template is restricted in the GCI, whether the usage of the template is restricted; and in a case in which the MRL mode is restricted or the usage of the template is restricted, skipping decoding the TMRL enabled flag, and determining that the value of the TMRL enabled flag is a value indicating that the TMRL mode is not allowed to be used; or in a case in which the MRL mode is not restricted and the usage of the template is not restricted, decoding a sequence-level identifier to determine the value of the TMRL enabled flag.

The process of decoding a sequence-level identifier to determine the value of the TMRL enabled flag in the above embodiment may include: decoding the TMRL enabled flag independently, or decoding the TMRL enabled flag depending on the MRL enabled flag and/or the template enabled flag.

The TMRL enabled flag in the above embodiment is a sequence-level identifier. In another embodiment, when the TMRL enabled flag is an image-level identifier or a slice-level identifier, a corresponding flag bit may alternatively be set in the GCI to indicate whether to restrict the TMRL mode (that is, indicate whether there is an image-level or slice-level TMRL enabled flag in the bitstream). If the corresponding flag bit indicates that the TMRL mode is restricted, it is determined that the value of the TMRL enabled flag is a value indicating that the TMRL mode is not allowed to be used, and the decoding of the TMRL enabled flag is skipped. If the corresponding flag bit indicates that the TMRL mode is not restricted and when the TMRL enabled flag is an image-level identifier, a sequence-level identifier and an image-level identifier may be decoded to determine the value of the TMRL enabled flag. When the TMRL enabled flag is a slice-level identifier, a sequence-level identifier, an image-level identifier, and a slice-level identifier may be decoded to determine the value of the TMRL enabled flag.

In an exemplary embodiment of this application, the TMRL enabled flag is used in combination with whether the TIMD mode is to be used for the current block, to control switching between decoding of a conventional MRL mode and decoding of an evolved TMRL mode. Whether the TIMD mode is to be used for the current block may be determined by decoding a TIMD mode flag (intra_timd_flag). The method further includes: determining whether a TIMD mode is to be used for the current block; and in a case in which the TIMD mode is to be used for the current block, decoding an MRL index for the current block, and skipping decoding a TMRL mode syntax element for the current block; or in a case in which the TIMD mode is not to be used for the current block, decoding a TMRL mode syntax element for the current block, and skipping decoding an MRL index for the current block.

In an exemplary embodiment of this application, the process of decoding a TMRL mode syntax element for the current block includes: decoding a TMRL mode flag for the current block to obtain a value of the TMRL mode flag, where the TMRL mode flag is used for indicating whether the TMRL mode is to be used for the current block; determining, based on the value of the TMRL mode flag, whether the TMRL mode is to be used for the current block; and in a case in which it is determined that the TMRL mode is to be used, decoding a TMRL mode index for the current block; or in a case in which the TMRL mode is not to be used, skipping decoding a TMRL mode index for the current block. In this embodiment, after the TMRL mode index for the current block is decoded, the method further includes: constructing a candidate list of the TMRL mode for the current block; determining, based on the TMRL mode index and the candidate list, a combination, selected for the current block, of an extended reference line and an intra prediction mode; and predicting the current block based on the selected combination to obtain a predicted value for the current block.

Changes in CU-level syntax elements related to this embodiment are shown in the table below.

| | Descriptor |
|---|---|
| coding_unit( x0, y0, cbWidth, cbHeight, cqtDepth, treeType, modeType ) { | |
| ... ... | |
| if( pred_mode_plt_flag ) | |
| palette_coding( x0, y0, cbWidth, cbHeight, treeType ) | |
| else { | |
| if( sps_bdpcm_enabled_flag && cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| else { | |
| if( sps_mip_enabled_flag ) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else { | |
| if( sps_timd_enable_flag && cbWidth * cbHeight <= 1024 ) | |
| intra_timd_flag | ae(v) |
| if( sps_mrl_enabled_flag && (( y0 % CtbSizeY ) > 0)) { | |
| if(!sps_tmrl_enabled_flag ∥ intra_timd_flag) { | |
| intra_luma_ref_idx | ae(v) |
| } | |
| else { /* sps_tmrl_enabled_flag && !intra_timd_flag */ | |
| cu_tmrl_flag | ae(v) |
| if( cu_tmrl_flag ) { | |
| tmrl_idx | ae(v) |
| } | |
| } | |
| } | |
| if( sps_mrl_enabled_flag && ( ( y0 % CtbSizeY ) > 0 ) && intra_timd_flag ) | |
| intra_luma_ref_idx | ae(v) |
| if( sps_isp_enabled_flag && intra_luma_ref_idx = = 0 && ( cbWidth <= | |
| MaxTbSizeY && cbHeight <= MaxTbSizeY ) && ( cbWidth * cbHeight > | |
| MinTbSizeY * MinTbSizeY ) && !cu_act_enabled_flag && !cu_tmrl_flag) | |
| intra_subpartitions_mode_flag | ae(v) |
| if( intra_subpartitions_mode_flag = = 1 ) | |
| intra_subpartitions_split_flag | ae(v) |
| if( !intra_timd_mode &&!cu_tmrl_flag ){ | |
| if( intra_luma_ref_idx = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainder[ x0 ][ y0 ] | ae(v) |
| } | |
| } | |
| } | |
| } | |
| } | |
| ... ... | |

A difference between the syntax table in the above embodiment and the syntax table in this embodiment lies in that whether to decode the block-level TMRL mode flag cu_tmrl_flag not only depends on the MRL mode being allowed to be used (sps_mrl_enabled_flag is 1), the current block being not on an upper edge of the CTU (((y0% CtbSizeY)>0), and the TIMD mode being not to be used for the current block (intra_timd_flag is 0, that is, !intra_timd_flag), but also depends on the TMRL mode being allowed to be used (sps_tmrl_enabled_flag is 1). Whether to decode cu_tmrl_flag may further depend on another mode, which cannot be used in combination with the TMRL mode, being not used. A multiple reference line index intra_luma_ref_idx is decoded when any one of the following conditions is met: the MRL mode is allowed to be used (sps_mrl_enabled_flag is 1), the current block is not located on an upper edge of the CTU(((y0% CtbSizeY)>0), the TIMD mode is to be used for the current block (intra_timd_flag is 0), and the TMRL mode is not allowed to be used (sps_tmrl_enabled_flag is 0).

In this embodiment, the combination of an extended reference line and an intra prediction mode may be an original combination of the extended reference line and the intra prediction mode, or may be a fused combination obtained by performing IPF on an original combination that includes a predetermined angular mode. For example, in a case that an original combination includes an extended reference line and a predetermined angular mode, a fused combination corresponding to the original combination refers to a combination of the extended reference line and the predetermined angular mode and a combination of another reference line and the predetermined angular mode. The process of predicting the current block based on the fused combination includes that: predicting the current block using the extended reference line and the predetermined angular mode to obtain a first prediction result, predicting the current block using another reference line and the predetermined angular mode to obtain a second prediction result, and using a weighted sum of the first prediction result and the second prediction result as a predicted value for the current block.

The predetermined angular mode may include all angular modes, or may include some of angular modes, for example, may include other angular modes than an angular mode of an integer slope, or may include other angular modes than angular modes with angles of −45°, 0°, 45°, 90°, and 135°. The another reference line in the fused combination may be a row adjacent to the extended reference line in the original combination (may be an adjacent row on an inner side or an adjacent row on an outer side), or may be a reference line with an index of 0.

For example, extended reference lines participating in the combination are reference lines with indexes of {1,3,5,7,12}. In a case that the original combination is a combination of a reference line with an index of 1 and an angular mode, a corresponding fused combination includes a combination of the reference line with the index of 1 and the angular mode and a combination of a reference line with an index of 2 (or an index of 0) and the angular mode. The process of predicting the current block based on the fused combination includes: performing weighting on a prediction result obtained using the reference line with the index of 1 and the angular mode and a prediction result obtained using the reference line with the index of 2 (or the index of 0) and the angular mode, to obtain a predicted value of the current block.

In an example of this embodiment, the process of constructing a candidate list of the TMRL mode for the current block includes:
obtaining, based on N extended reference lines and M intra prediction modes for the current block, N×M original combinations of the extended reference lines and the intra prediction modes;
performing intra prediction fusion IPF on an original combination including a predetermined angular mode in the N×M original combinations to obtain a fused combination;
predicting a template region of the current block based on each of the N×M original combinations and the obtained fused combination, and calculating differences between reconstructed values for the template region and a predicted value obtained by prediction; and
filling the candidate list of the TMRL mode for the current block with K combinations corresponding to the differences in ascending order of the differences, where K, N, and M are positive integers, and 1≤K≤N×M.

In another example of this embodiment, the process of constructing a candidate list of the TMRL mode for the current block includes:
obtaining, based on N extended reference lines and M intra prediction modes for the current block, N×M original combinations of the extended reference lines and the intra prediction modes;
predicting a template region of the current block based on each of the N×M original combinations, and calculating differences between reconstructed values for the template region and a predicted value obtained by prediction; and
determining whether to perform fusion on each combination that includes a predefined angular mode in K original combinations with the smallest errors; and in a case in which the fusion is to be performed, performing IPF on the original combination to obtain a fused combination, and filling the candidate list with the fused combination; or in a case in which the fusion is not to be performed, filling the candidate list with the original combination, where K, N, and M are positive integers, and 1≤K≤N×M.

In this example, the process of determining whether to perform fusion on each combination includes: predicting a template region of the current block based on a fused combination corresponding to the original combination; calculating a difference between a reconstructed value for the template region and the predicted value obtained by prediction; and in a case in which a difference corresponding to the original combination is greater than a difference corresponding to the fused combination, determining that the fusion is to be performed; or in a case in which a difference corresponding to the original combination is less than or equal to a difference corresponding to the fused combination, determining that the fusion is not to be performed.

In still another example of this embodiment, the process of constructing a candidate list of the TMRL mode for the current block includes:
obtaining, based on N extended reference lines and M intra prediction modes for the current block, N×M original combinations of the extended reference lines and the intra prediction modes;
performing fusion processing on the N×M original combinations, where the fusion processing includes: when a predetermined condition is met, replacing each original combination including a predetermined angular mode in the N×M original combinations with a fused combination obtained by performing IPF on the original combination;
predicting a template region of the current block based on each of the N×M combinations subjected to fusion processing, and calculating differences between reconstructed values for the template region and the predicted value obtained by prediction; and
filling the candidate list of the TMRL mode for the current block with K combinations corresponding to the differences in ascending order of the differences, where K, N, and M are positive integers, and 1≤K≤N×M.

In this example, the predetermined condition includes one or more of the following conditions: a size of the current block is greater than N×M, and N and M are positive integers; and an intra prediction mode selected for the current block is not an angular mode of an integer slope. The predetermined condition is not limited in this example.

The three examples in this embodiment provide three methods of constructing the candidate list of the TMRL by using the IPF, which can improve encoding efficiency of the TMRL mode using the IPF method.

In the above example using IPF in this embodiment, the process of predicting the current block based on the selected combination to obtain a predicted value for the current block includes:
in a case in which the selected combination is an original combination, predicting the current block based on an extended reference line and an intra prediction mode in the original combination, to obtain the predicted value for the current block; and
in a case in which the selected combination is a fused combination, using a weighted sum of a first prediction result and a second prediction result as the predicted value for the current block, where the first prediction result is obtained by predicting the current block based on an extended reference line and a predetermined angular mode in an original combination corresponding to the fused combination, and the second prediction result is obtained by predicting the current block based on a predetermined angular mode in an original combination corresponding to the fused combination and another reference line. As described above, the another reference line may be adjacent to an extended reference line in the original combination corresponding to the fused combination, or may be a reference line with an index of 0.

In this example, the weighted sum of the first prediction result and the second prediction result may be calculated according to following formula:

p_{fusion}=(wₐpₐ+w_{b}p_{b})>>shift, or

p_{fusion}=(wₐpₐ+w_{b}p_{b}+offset)>>shift
where pₐ denotes the first prediction result, p_{b} denotes the second prediction result, p_{fusion} denotes a final prediction result for the current block, wₐ denotes a weight of pₐ, and w_{b} denotes a weight of p_{b}; and
wₐ+w_{b}=(1<<shift), offset=1<<(shift−1), shift≥1, and shift and offset are set parameters.

Generally, a sum of two weights assigned to the two prediction results is 1. To avoid decimal calculations, wₐ and w_{b} in the above formula are weights scaled up by a left shift operation, and therefore wₐ+w_{b}=(1<<shift). The predicted value is restored by a right shift operation in the formula. In the formula, “>>” is a right shift symbol, “<<” is a left shift symbol, and a value located on the right side of the symbol indicates the number of bits for the right or left shift.

An embodiment of this application further provides a video encoding method, applied to an encoder. As shown in FIG. 11, the video encoding method includes the following steps 510 and 520.

In step 510, a value of a TMRL enabled flag is determined.

In step 520, during encoding of a current block: in a case in which the value of the TMRL enabled flag indicates that a TMRL mode is allowed to be used, encoding of a TMRL mode syntax element for the current block is allowed; or in a case in which the value of the TMRL enabled flag indicates that a TMRL mode is not allowed to be used, encoding of a TMRL mode syntax element for the current block is skipped.

In this embodiment, the usage of the TMRL mode and the encoding of the syntax element are controlled based on the value of the TMRL enabled flag, which can improve flexibility and adaptability of using the TMRL mode. In an example, in a case that the TMRL mode is not supported by hardware, the value of the TMRL enabled flag is set to 0, indicating that the TMRL mode is not allowed to be used. In a case that the TMRL mode is supported by hardware, the value of the TMRL enabled flag is set to 1, indicating that the TMRL mode is allowed to be used.

In an exemplary embodiment of this application, the TMRL enabled flag is a sequence-level identifier. In another embodiment, the TMRL enabled flag may be an image-level identifier or a slice-level identifier.

In an exemplary embodiment of this application, the TMRL enabled flag may be encoded independently, without relying on other flags. In this case, the value of the TMRL enabled flag may be determined based on configuration information or a predetermined condition, and the TMRL enabled flag is encoded. The configuration information may be recorded in a configuration file. The predetermined condition may be other conditions apart from flags, such as an image size, an image quality requirement, a transmission bandwidth, available computing resources, and the like. The TMRL enabled flag is a one-bit identifier, with a value of 0 or 1. The value of the TMRL enabled flag may be directly encoded into the bitstream.

In an exemplary embodiment of this application, the encoding of the TMRL enabled flag depends on the MRL enabled flag. The process of determining a value of a TMRL enabled flag includes: determining a value of an MRL enabled flag; in a case in which the value of the MRL enabled flag indicates that MRL is not allowed to be used, skipping encoding the TMRL enabled flag, and setting, by default, the value of the TMRL enabled flag to a value indicating that the TMRL mode is not allowed to be used; or in a case in which the MRL enabled flag indicates that MRL is allowed to be used, determining the value of the TMRL enabled flag based on configuration information or a predetermined condition, and encoding the TMRL enabled flag. In this embodiment, the value of the MRL enabled flag may be determined based on configuration information or a predetermined condition.

In this embodiment, the TMRL enabled flag is a sequence-level identifier, and the MRL enabled flag is a sequence-level identifier. In another embodiment, the TMRL enabled flag is an image-level identifier, and the MRL enabled flag may be a sequence-level identifier or an image-level identifier. In still another embodiment, the TMRL enabled flag is a slice-level identifier, and the MRL enabled flag may be a sequence-level identifier, an image-level identifier, or a slice-level identifier. In these embodiments, when the TMRL enabled flag and the MRL enabled flag are identifiers of a same level, the MRL enabled flag is encoded before the TMRL enabled flag.

In an exemplary embodiment of this application, the encoding of the TMRL enabled flag depends on the template enabled flag. The process of determining a value of a TMRL enabled flag includes: determining a value of a template enabled flag; in a case in which the value of the template enabled flag indicates that a template is not allowed to be used, skipping encoding the TMRL enabled flag, and setting, by default, the value of the TMRL enabled flag to a value indicating that the TMRL mode is not allowed to be used; or in a case in which the template enabled flag indicates that a template is allowed to be used, determining the value of the TMRL enabled flag based on configuration information or a predetermined condition, and encoding the TMRL enabled flag. The value of the template enabled flag may be determined based on configuration information or a predetermined condition.

In this embodiment, the TMRL enabled flag is a sequence-level identifier, and the template enabled flag is a sequence-level identifier. In another embodiment, the TMRL enabled flag is an image-level identifier, and the template enabled flag may be a sequence-level identifier or an image-level identifier. In still another embodiment, the TMRL enabled flag is a slice-level identifier, and the template enabled flag may be a sequence-level identifier, an image-level identifier, or a slice-level identifier. In these embodiments, when the TMRL enabled flag and the template enabled flag are identifiers of a same level, the template enabled flag is encoded before the TMRL enabled flag.

In an exemplary embodiment of this application, encoding of the TMRL enabled flag depends on the template enabled flag and the MRL enabled flag. The process of determining a value of a TMRL enabled flag includes: determining a value of an MRL enabled flag and a value of a template enabled flag; in a case in which the value of the MRL enabled flag indicates that MRL is allowed to be used, and the value of the template enabled flag indicates that a template is allowed to be used, determining the value of the TMRL enabled flag based on configuration information or a predetermined condition, and encoding the TMRL enabled flag; or in a case in which the value of the MRL enabled flag indicates that MRL is not allowed to be used, or the value of the template enabled flag indicates that a template is not allowed to be used, skipping encoding the TMRL enabled flag, and setting, by default, the value of the TMRL enabled flag to a value indicating that the TMRL mode is not allowed to be used.

In this embodiment, the TMRL enabled flag is a sequence-level identifier, and the MRL enabled flag and the template enabled flag are sequence-level identifiers. In another embodiment, the TMRL enabled flag is an image-level identifier, and the MRL enabled flag and the template enabled flag may be sequence-level identifiers or image-level identifiers. In still another embodiment, the TMRL enabled flag is a slice-level identifier, and the MRL enabled flag and the template enabled flag may be sequence-level identifiers, image-level identifiers, or slice-level identifiers. In these embodiments, when the TMRL enabled flag, the MRL enabled flag, and the template enabled flag are identifiers of a same level, the MRL enabled flag and the template enabled flag are encoded before the TMRL enabled flag.

In a case that the TMRL enabled flag is a sequence-level identifier, the usage of the TMRL mode may be restricted by a flag bit set in the GCI. In a case that a value of the flag bit indicates that the MRL mode is restricted, the TMRL enabled flag is unnecessary to be encoded.

In an exemplary embodiment of this application, a flag bit set in the GCI indicates whether the TMRL mode is restricted. Whether the TMRL mode is restricted does not depend on another flag bit in the GCI. In this embodiment, the TMRL enabled flag is a sequence-level identifier, and the process of determining a value of a TMRL enabled flag includes: determining, based on a value of a flag bit used for indicating whether the TMRL mode is restricted in the GCI, whether the TMRL mode is restricted; and in a case in which the TMRL mode is restricted, skipping encoding the TMRL enabled flag, and determining that the value of the TMRL enabled flag is a value indicating that the TMRL mode is not allowed to be used; or in a case in which the TMRL mode is not restricted, encoding a sequence-level identifier to determine the value of the TMRL enabled flag.

In an exemplary embodiment of this application, a flag bit set in the GCI indicates whether the MRL mode is restricted. When the MRL mode is restricted, the TMRL mode is also restricted. In this embodiment, the TMRL enabled flag is a sequence-level identifier, and the process of determining a value of a TMRL enabled flag includes: determining, based on a value of a flag bit used for indicating whether MRL is restricted in the GCI, whether the MRL mode is restricted; and in a case in which the MRL mode is restricted, skipping encoding the TMRL enabled flag, and determining that the value of the TMRL enabled flag is a value indicating that the TMRL mode is not allowed to be used; or in a case in which the MRL mode is not restricted, encoding a sequence-level identifier to determine the value of the TMRL enabled flag.

In an exemplary embodiment of this application, a flag bit set in the GCI indicates whether usage of a template is restricted. When the MRL mode is restricted or the usage of the template is restricted, the TMRL mode is also restricted. In this embodiment, the TMRL enabled flag is a sequence-level identifier, and the process of determining a value of a TMRL enabled flag includes: determining, based on a value of a flag bit used for indicating whether usage of a template is restricted in the GCI, whether the usage of the template is restricted; and in a case in which the usage of the template is restricted, skipping encoding the TMRL enabled flag, and determining that the value of the TMRL enabled flag is a value indicating that the TMRL mode is not allowed to be used; or in a case in which the usage of the template is not restricted, encoding a sequence-level identifier to determine the value of the TMRL enabled flag.

In an exemplary embodiment of this application, two flag bits set in the GCI indicate whether the MRL mode is restricted and whether the usage of the template is restricted, respectively. When the MRL mode is restricted or the usage of the template is restricted, the TMRL mode is also restricted. In this embodiment, the TMRL enabled flag is a sequence-level identifier, and the process of determining a value of a TMRL enabled flag includes: determining, based on a value of a flag bit used for indicating whether an MRL mode is restricted in the GCI, whether the MRL mode is restricted, and determining, based on a value of a flag bit used for indicating whether usage of a template is restricted in the GCI, whether the usage of the template is restricted; and in a case in which the MRL mode is restricted or the usage of the template is restricted, skipping encoding the TMRL enabled flag, and determining that the value of the TMRL enabled flag is a value indicating that the TMRL mode is not allowed to be used; or in a case in which the MRL mode is not restricted or the usage of the template is not restricted, encoding a sequence-level identifier to determine the value of the TMRL enabled flag.

In the above embodiment, the process of encoding a sequence-level identifier to determine the value of the TMRL enabled flag may include: encoding the TMRL enabled flag independently, to determine the value of the TMRL enabled flag based on configuration information or a predetermined condition; or encoding the TMRL enabled flag depending on the MRL enabled flag and/or the template enabled flag, to determine the value of the TMRL enabled flag.

The TMRL enabled flag in the above embodiment is a sequence-level identifier. In another embodiment, when the TMRL enabled flag is an image-level identifier or a slice-level identifier, a flag bit may be set in the GCI to indicate whether to restrict the TMRL mode (that is, indicate whether there is an image-level or slice-level TMRL enabled flag in the bitstream). If the corresponding flag bit indicates that the TMRL mode is restricted, it is determined that the value of the TMRL enabled flag is a value indicating that the TMRL mode is not allowed to be used, and encoding of the TMRL enabled flag is skipped. If the corresponding flag bit indicates that the TMRL mode is not restricted and when the TMRL enabled flag is an image-level identifier, a sequence-level identifier and an image-level identifier may be decoded to determine the value of the TMRL enabled flag. When the TMRL enabled flag is a slice-level identifier, a sequence-level identifier, an image-level identifier, and a slice-level identifier may be encoded to determine the value of the TMRL enabled flag.

In an exemplary embodiment of this application, the TMRL enabled flag is used in combination with whether the TIMD mode is used for the current block, to control switching between encoding of a conventional MRL mode and encoding of an evolved TMRL mode. Whether the TIMD mode is used for the current block may be determined based on a value of a TIMD mode flag (intra_timd_flag). In this embodiment, in a case in which the value of the TMRL enabled flag indicates that the TMRL mode is allowed to be used, the method further includes: determining whether a TIMD mode is to be used for the current block; and in a case in which the TIMD mode is to be used for the current block, encoding an MRL index for the current block, and skipping encoding the TMRL mode syntax element for the current block; or in a case in which the TIMD mode is not to be used for the current block, encoding the TMRL mode syntax element for the current block, and skipping encoding an MRL index for the current block.

In an exemplary embodiment of this application, the process of encoding a TMRL mode syntax element for the current block includes: constructing a candidate list of the TMRL mode for the current block; selecting a combination of a reference line and an intra prediction mode for the current block through rate-distortion optimization; and when an encoding condition for the TMRL mode for the current block is met, encoding a TMRL mode flag for the current block to indicate that the TMRL mode is to be used for the current block, and encoding a TMRL mode index for the current block to indicate a location of the selected combination in the candidate list. The encoding condition includes at least: the selected combination being in the candidate list (in this case, the selected reference line is an extended reference line).

In an example of this embodiment, the encoding condition further includes any one or more of following: the current block being a block in a luma frame; the current block being not located at an upper boundary of a coding tree unit CTU; multiple reference lines MRL being allowed to be used for the current block; a template being allowed to be used for the current block; a size of the current block meeting a size requirement for the current block when the TMRL mode is used; or a length-width ratio of the current block meeting a length-width ratio requirement for the current block when the TMRL mode is used.

In an example of this embodiment, the construction of the candidate list of the TMRL may include: performing IPF on an original combination of an extended reference line and an angular mode to obtain a fused combination, and filling the candidate list with the fused combination. In this case, the combination of a reference line and an intra prediction mode may be a combination of a reference line with an index of 0 and the intra prediction mode, or may be an original combination of an extended reference line and an intra prediction mode, or a fused combination, obtained by performing IPF on an original combination, of an extended reference line and an intra prediction mode. The candidate list may be filled with the fused combination by using any method for constructing the candidate list of the TMRL mode for the current block by performing IPF in the above embodiments, and details are not repeated here.

An embodiment of this application further provides a bitstream. The bitstream is generated by using the video encoding method according to any one of the embodiments of this application.

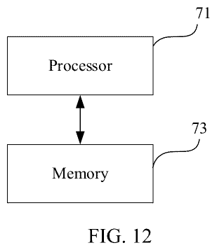

An embodiment of this application further provides a video decoding apparatus. As shown in FIG. 12, the video decoding apparatus includes a processor 71 and a memory 73 storing a computer program, where the computer program is executed by the processor 71 to implement the video decoding method according to any one of the embodiments of this application.

An embodiment of this application further provides a video encoding apparatus. The video encoding apparatus includes a processor and a memory storing a computer program, where the computer program is executed by the processor to implement the video encoding method according to any one of the embodiments of this application.

An embodiment of this application further provides a video coding system. The video coding system includes the video encoding apparatus according to any one of the embodiments of this application and the video decoding apparatus according to any one of the embodiments of this application.

An embodiment of this application further provides a non-transitory computer-readable storage medium storing a computer program. The computer program is executed by a processor to implement the video decoding method according to any one of the embodiments of this application, or to implement the video encoding method according to any one of the embodiments of this application.

The processor in the above embodiment of this application may be a general-purpose processor, including a central processing unit (CPU), a network processor (Network Processor, NP for short), a microprocessor, or the like, or may be another conventional processor. The processor may alternatively be a digital signal processor (DSP), an application-specific integrated circuit (ASIC), a field programmable gate array (FPGA), a discrete logic or another programmable logic device, a discrete gate or transistor logic device, a discrete hardware component, another equivalent integrated or discrete logic circuit, or a combination thereof. In other words, the processor in the above embodiment may be any processing device or a combination of devices that implement the methods, steps, and logic diagrams disclosed in the embodiments of this application. If the embodiments of this application are partially implemented in software, instructions for the software may be stored in a suitable non-volatile computer-readable storage medium, and the instructions may be executed in hardware by one or more processors to implement the methods in the embodiments of this application. The term “processor” used herein may refer to the structure described above or any other structure suitable for implementing the techniques described herein.

In one or more exemplary embodiments above, the functions described may be implemented in hardware, software, firmware, or any combination thereof. If the embodiments are implemented in software, functionality may be stored as one or more instructions or code on a computer-readable medium or transmitted via a computer-readable medium and executed by a hardware-based processing unit. The computer-readable medium may include a computer-readable storage medium corresponding to a tangible medium, such as a data storage medium, or a communication medium that facilitates transfer of a computer program, for example, from one location to another according to a communication protocol. In this way, the computer-readable medium may generally correspond to a non-transitory tangible computer-readable storage medium or a communication medium such as a signal or a carrier. The data storage medium may be any available medium that may be accessed by one or more computers or one or more processors to retrieve instructions, code, and/or data structures for implementing the techniques described in the embodiments of this application. A computer program product may include a computer-readable medium.

By way of example instead of limitation, such a computer-readable storage medium may include a RAM, a ROM, an EEPROM, a CD-ROM, or other optical disk storage apparatuses, magnetic disk storage apparatuses, or other magnetic storage apparatuses, a flash memory, or any other medium that can be used to store desired program code in the form of instructions or data structures and that can be accessed by a computer. In addition, any connection may be referred to as a computer-readable medium. For example, if instructions are transmitted from a web site, a server, or other remote sources using a coaxial cable, a fiber optic cable, a twisted pair, a digital subscriber line (DSL), or wireless technologies such as infrared rays, radio, and microwaves, the coaxial cable, the fiber optic cable, the twisted pair, the DSL, or the wireless technologies such as infrared rays, radio, and microwaves are included in the definition of the medium. However, it should be understood that the computer-readable storage medium and the data storage medium do not include connections, carriers, signals, or other temporary (transient) media, but refer specifically to non-transitory tangible storage media. As used herein, disks and optical discs include compact discs (CD), laser discs, optical discs, digital versatile discs (DVD), floppy disks, Blu-ray discs, and the like. In these cases, disks generally regenerate data magnetically, while optical discs regenerate data optically using lasers. A combination of the above should also be included within the range of the computer-readable medium.

In some aspects, the functionality described herein may be provided within dedicated hardware and/or software modules configured for encoding and decoding, or integrated into a combined codec. Furthermore, the techniques may be fully implemented in one or more circuits or logic elements.

The technical solutions of the embodiments of this application may be implemented in a wide range of apparatuses or devices, including mobile phones, integrated circuits (ICs), or a set of ICs (e.g., a chipset). Various components, modules, or units are described in embodiments of this application to emphasize functional aspects of apparatuses configured to perform the described techniques, but they are not necessarily implemented through different hardware units. Instead, as described above, the various units can be combined within codec hardware units or provided by a collection of interoperating hardware units (including one or more processors as mentioned above) along with appropriate software and/or firmware.

What is claimed is:

1. A video decoding method, applied to a decoder, the video decoding method comprising:
determining a value of a template-based multiple reference line intra prediction TMRL enabled flag by decoding; and
during decoding of a current block:
in a case in which the value of the TMRL enabled flag indicates that a TMRL mode is allowed to be used, allowing to decode a TMRL mode syntax element for the current block; or
in a case in which the value of the TMRL enabled flag indicates that a TMRL mode is not allowed to be used, skipping decoding a TMRL mode syntax element for the current block.

2. The method according to claim 1, wherein
the TMRL enabled flag is a sequence-level identifier, an image-level identifier, or a slice-level identifier.

3. The method according to claim 1, wherein
the determining a value of a TMRL enabled flag by decoding comprises: decoding the TMRL enabled flag to obtain the value of the TMRL enabled flag.

4. The method according to claim 1, wherein
the determining a value of a TMRL enabled flag by decoding comprises:
decoding an MRL enabled flag to obtain a value of the MRL enabled flag; and
in a case in which the value of the MRL enabled flag indicates that MRL is not allowed to be used, skipping decoding the TMRL enabled flag, and determining, by default, the value of the TMRL enabled flag to a value indicating that the TMRL mode is not allowed to be used; or
in a case in which the value of the MRL enabled flag indicates that MRL is allowed to be used, decoding the TMRL enabled flag to obtain the value of the TMRL enabled flag.

5. The method according to claim 1, wherein
the determining a value of a TMRL enabled flag by decoding comprises:
decoding a template enabled flag to obtain a value of the template enabled flag; and
in a case in which the value of the template enabled flag indicates that a template is not allowed to be used, skipping decoding the TMRL enabled flag, and determining, by default, the value of the TMRL enabled flag to a value indicating that the TMRL mode is not allowed to be used; or
in a case in which the value of the template enabled flag indicates that a template is allowed to be used, decoding the TMRL enabled flag to obtain the value of the TMRL enabled flag.

6. The method according to claim 1, wherein
the determining a value of a TMRL enabled flag by decoding comprises:
decoding an MRL enabled flag and a template enabled flag to obtain a value of the MRL enabled flag and a value of the template enabled flag; and
in a case in which the value of the MRL enabled flag indicates that MRL is allowed to be used, and the value of the template enabled flag indicates that a template is allowed to be used, decoding the TMRL enabled flag to obtain the value of the TMRL enabled flag; or
in a case in which the value of the MRL enabled flag indicates that MRL is not allowed to be used, or the value of the template enabled flag indicates that a template is not allowed to be used, skipping decoding the TMRL enabled flag, and determining, by default, the value of the TMRL enabled flag to a value indicating that the TMRL mode is not allowed to be used.

7. The method according to claim 1, wherein
the TMRL enabled flag is a sequence-level identifier, and the determining a value of a TMRL enabled flag by decoding comprises:
decoding general constraints information GCI, and determining, based on a value of a flag bit used for indicating whether the TMRL mode is restricted in the GCI, whether the TMRL mode is restricted; and
in a case in which the TMRL mode is restricted, skipping decoding the TMRL enabled flag, and determining that the value of the TMRL enabled flag indicates that the TMRL mode is not allowed to be used; or
in a case in which the TMRL mode is not restricted, decoding a sequence-level identifier to determine the value of the TMRL enabled flag.

8. The method according to claim 1, wherein
the TMRL enabled flag is a sequence-level identifier, and the determining a value of a TMRL enabled flag by decoding comprises:
decoding GCI, and determining, based on a value of a flag bit used for indicating whether MRL is restricted in the GCI, whether an MRL mode is restricted; and
in a case in which the MRL mode is restricted, skipping decoding the TMRL enabled flag, and determining that the value of the TMRL enabled flag indicates that the TMRL mode is not allowed to be used; or
in a case in which the MRL mode is not restricted, decoding a sequence-level identifier to determine the value of the TMRL enabled flag.

9. The method according to claim 1, wherein the TMRL enabled flag is a sequence-level identifier, and the determining a value of a TMRL enabled flag by decoding comprises:
decoding GCI, and determining, based on a value of a flag bit used for indicating whether usage of a template is restricted in the GCI, whether the usage of the template is restricted; and
in a case in which the usage of the template is restricted, skipping decoding the TMRL enabled flag, and determining that the value of the TMRL enabled flag indicates that the TMRL mode is not allowed to be used; or
in a case in which the usage of the template is not restricted, decoding a sequence-level identifier to determine the value of the TMRL enabled flag.

10. The method according to claim 1, wherein the TMRL enabled flag is a sequence-level identifier, and the determining a value of a TMRL enabled flag by decoding comprises:
decoding GCI, and determining, based on a value of a flag bit used for indicating whether an MRL mode is restricted in the GCI, whether the MRL mode is restricted, and determining, based on a value of a flag bit used for indicating whether usage of a template is restricted in the GCI, whether the usage of the template is restricted; and
in a case in which the MRL mode is restricted or the usage of the template is restricted, skipping decoding the TMRL enabled flag, and determining that the value of the TMRL enabled flag indicates that the TMRL mode is not allowed to be used; or
in a case in which the MRL mode is not restricted or the usage of the template is not restricted, decoding a sequence-level identifier to determine the value of the TMRL enabled flag.

11. The method according to claim 1, wherein
in a case in which the value of the TMRL enabled flag indicates that the TMRL mode is allowed to be used, the method further comprises:
determining whether a template-based intra mode derivation TIMD mode is to be used for the current block; and
in a case in which the TIMD mode is to be used for the current block, decoding a multiple reference line MRL index for the current block, and skipping decoding a TMRL mode syntax element for the current block; or
in a case in which the TIMD mode is not to be used for the current block, decoding a TMRL mode syntax element for the current block, and skipping decoding an MRL index for the current block.

12. The method according to claim 1, wherein
the decoding a TMRL mode syntax element for the current block comprises:
decoding a TMRL mode flag for the current block to obtain a value of the TMRL mode flag, wherein the TMRL mode flag is used for indicating whether the TMRL mode is to be used for the current block; and
determining, based on the value of the TMRL mode flag, whether the TMRL mode is to be used for the current block; and in a case in which it is determined that the TMRL mode is to be used, decoding a TMRL mode index for the current block; or in a case in which it is determined that the TMRL mode is not to be used, skipping decoding a TMRL mode index for the current block,
wherein after the TMRL mode index for the current block is decoded, the method further comprises:
constructing a candidate list of the TMRL mode for the current block; determining, based on the TMRL mode index and the candidate list, a combination, selected for the current block, of an extended reference line and an intra prediction mode; and predicting the current block based on the selected combination to obtain a predicted value for the current block.

13. The method according to claim 12, wherein
the predicting the current block based on the selected combination to obtain a predicted value for the current block comprises:
in a case in which the selected combination is an original combination, predicting the current block based on an extended reference line and an intra prediction mode in the original combination, to obtain the predicted value for the current block; and
in a case in which the selected combination is a fused combination, using a weighted sum of a first prediction result and a second prediction result as the predicted value for the current block, wherein the first prediction result is obtained by predicting the current block based on an extended reference line and a predetermined angular mode in an original combination corresponding to the fused combination, and the second prediction result is obtained by predicting the current block based on another reference line and a predetermined angular mode in an original combination corresponding to the fused combination.

14. The method according to claim 13, wherein
the predetermined angular mode comprises all angular modes, or comprises other angular modes than an angular mode of an integer slope;
the another reference line is adjacent to an extended reference line in the original combination corresponding to the fused combination, or the another reference line is a reference line with an index of 0.

15. The method according to claim 13, wherein
the weighted sum of the first prediction result and the second prediction result is calculated according to following formula:
p_{fusion}=(wₐpₐ+w_{b}p_{b})>>shift
or
p_{fusion}=(wₐpₐ+w_{b}p_{b}+offset)>>shift
wherein pₐ denotes the first prediction result, p_{b} denotes the second prediction result, p_{fusion} denotes a final prediction result for the current block, wₐ denotes a weight of pₐ, and w_{b} denotes a weight of p_{b};
wherein wₐ+w_{b}=(1<<shift), offset=1<<(shift−1), shift≥1, and both shift and offset are set parameters.

16. A video decoder, comprising a memory and a processor, wherein the memory is configured to store at least program, and the processor is configured to execute the program stored in the memory to cause the video decoder to perform operations comprising:
determining a value of a template-based multiple reference line intra prediction TMRL enabled flag by decoding; and
during decoding of a current block:
in a case in which the value of the TMRL enabled flag indicates that a TMRL mode is allowed to be used, allowing to decode a TMRL mode syntax element for the current block; or
in a case in which the value of the TMRL enabled flag indicates that a TMRL mode is not allowed to be used, skipping decoding a TMRL mode syntax element for the current block.

17. The video decoder according to claim 16, wherein the TMRL enabled flag is a sequence-level identifier, an image-level identifier, or a slice-level identifier.

18. The video decoder according to claim 16, wherein
the determining a value of a TMRL enabled flag by decoding comprises: decoding the TMRL enabled flag to obtain the value of the TMRL enabled flag.

19. The video decoder according to claim 16, wherein
the determining a value of a TMRL enabled flag by decoding comprises:
decoding an MRL enabled flag to obtain a value of the MRL enabled flag; and
in a case in which the value of the MRL enabled flag indicates that MRL is not allowed to be used, skipping decoding the TMRL enabled flag, and determining, by default, the value of the TMRL enabled flag to a value indicating that the TMRL mode is not allowed to be used; or
in a case in which the value of the MRL enabled flag indicates that MRL is allowed to be used, decoding the TMRL enabled flag to obtain the value of the TMRL enabled flag.

20. A video encoding method, applied to an encoder, the video encoding method comprising:
determining a value of a template-based multiple reference line intra prediction TMRL enabled flag; and
during encoding of a current block:
in a case in which the value of the TMRL enabled flag indicates that a TMRL mode is allowed to be used, allowing to encode a TMRL mode syntax element for the current block; or
in a case in which the value of the TMRL enabled flag indicates that a TMRL mode is not allowed to be used, skipping encoding a TMRL mode syntax element for the current block.
